(19) United States
(12) Patent Application Publication
(10) Pub. No.: US 2023/0032048 A1
(43) Pub. Date: Feb. 2, 2023

(54) CELLULOSIC COMPOSITE MATERIALS AND METHODS THEREOF

(71) Applicant: DTE Materials Incorporated, Fresno, CA (US)

(72) Inventors: Tanner Jon JOLLY, Friant, CA (US); Jose Abilio URIZAR, Los Angeles, CA (US)

(21) Appl. No.: 17/819,521

(22) Filed: Aug. 12, 2022

Related U.S. Application Data
(63) Continuation of application No. PCT/US2021/018578, filed on Feb. 18, 2021.
(60) Provisional application No. 63/088,644, filed on Oct. 7, 2020.
(60) Provisional application No. 62/995,877, filed on Feb. 18, 2020.

(51) Int. Cl. C04B 16/02; C04B 28/10; C04B 28/18

(52) U.S. Cl. CPC C04B 16/02; C04B 28/10; C04B 28/18; C04B 2103/67

(57) ABSTRACT

The present disclosure provides compositions and methods of manufacture of a composite material. In an aspect, the composite material may comprise a cellulosic material and a binder material. In some cases, at least a portion of the cellulosic material may be delignified. In some cases, at least a portion of crystal structure of the cellulosic material may be maintained in the composite material. In some cases, the cellulosic material may comprise a plurality of pores. In some cases, the binder may comprise lime comprising calcium oxide or calcium hydroxide. In some cases, the binder may further comprise silicate.

### CROSS-REFERENCE

This application is a continuation application of International Application No. PCT/US2021/018578, filed on Feb. 18, 2021, which claims the benefit of U.S. Provisional Pat. Application Serial No. 62/995,877, filed Feb. 18, 2020, and U.S. Provisional Pat. Application Serial No. 63/088,644, filed Oct. 7, 2020, each of which is incorporated herein by reference in its entirety.

### BACKGROUND

Cellulosic materials can be used as building insulation materials. The cellulosic materials can be broken down into pieces and inserted into (e.g., blown in) cavities of roofs, walls, or floors, e.g., to provide thermal and acoustic insulation.

### SUMMARY

An aspect of the present disclosure provides a composite material, comprising: a cellulosic material characterized by one or more members selected from the group consisting of (i) at least a portion of the cellulosic material is delignified, (ii) at least a portion of crystal structure of the cellulosic material is maintained, and (iii) the cellulosic material comprises a plurality of pores; and a binder material comprising lime, wherein the lime comprises calcium oxide or calcium hydroxide.

In some embodiments, the lime comprises calcium oxide and calcium hydroxide.

In some embodiments of any one of the subject composite materials, the binder material further comprises silica. In some embodiments of any one of the subject composite materials, a weight ratio of the silica (S) and the lime (L) is between about 1:1 and about 1:5 (S:L). In some embodiments of any one of the subject composite materials, a weight ratio of the silica (S) and the lime (L) is about 1:3 (S:L).

In some embodiments of any one of the subject composite materials, a weight ratio of the binder material (BM) to the cellulosic material (CM) is between about 1:10 and about 20:10 (BM:CM). In some embodiments, the weight ratio of the binder material (BM) to the cellulosic material (CM) is between about 7:10 and about 15:10 (BM:CM). In some embodiments, the weight ratio of the binder material (BM) to the cellulosic material (CM) is between about 1:10 and about 2:10.

In some embodiments of any one of the subject composite materials, the binder material further comprises silicate. In some embodiments, the silicate comprises silicate nanocrystals or silicate microcrystals. In some embodiments, the silicate comprises calcium silicate hydrate (C-S-H) nanocrystals or C-S-H microcrystals.

In some embodiments of any one of the subject composite materials, the cellulosic material comprises one or more members selected from the group consisting of: a bast fiber, leaf, seed, fruit, grass, and wood. In some embodiments of any one of the subject composite materials, the cellulosic material comprises a hemp bast fiber.

In some embodiments of any one of the subject composite materials, the cellulosic material comprises hemp long bast fiber or short hurd fiber. In some embodiments, the cellulosic material comprises the hemp long bast fiber and the short hurd fiber

In some embodiments of any one of the subject composite materials, the cellulosic material characterized by two or more members selected from the group consisting of (i) at least a portion of the cellulosic material is delignified, (ii) at least a portion of crystal structure of the cellulosic material is maintained, and (iii) the cellulosic material comprises a plurality of pores. In some embodiments of any one of the subject composite materials, the cellulosic material characterized by (i) at least a portion of the cellulosic material is delignified, (ii) at least a portion of crystal structure of the cellulosic material is maintained, and (iii) the cellulosic material comprises a plurality of pores.

In some embodiments of any one of the subject composite materials, the composite material is characterized by having a density between about 1 pounds per cubic foot (lb/ft³) and about 100 lbs/ft³. In some embodiments of any one of the subject composite materials, the composite material is characterized by having a density between about 1 lb/ft³ and about 30 lbs/ft³. In some embodiments of any one of the subject composite materials, the composite material has a density between about 5 lb/ft³ and 25 lb/ft³. In some embodiments of any one of the subject composite materials, the composite material is characterized by having a density of at least about 5 lbs/ft³.

In some embodiments of any one of the subject composite materials, the composite material is usable as a thermal or acoustic insulator for a building.

In some embodiments of any one of the subject composite materials, the composite material exhibits a biocidal activity against a microorganism.

In some embodiments of any one of the subject composite materials, the cellulosic material exhibits enhanced shelf-life as compared to a cellulosic material that does not exhibit the characterization.

Another aspect of the present disclosure provides a method for generating a composite material, comprising: (a) providing (1) a cellulosic material characterized by one or more members selected from the group consisting of: (i) at least a portion of the cellulosic material is delignified, (ii) at least a portion of crystal structure of the cellulosic material is maintained, and (iii) the cellulosic material comprises a plurality of pores and (2) a binder material comprising lime, wherein the lime comprises calcium oxide or calcium hydroxide; and (b) mixing the cellulosic material and the binder material, to generate the composite material.

In some embodiments of any one of the subject methods, wherein the cellulosic material is at least partially dried by an external pressure. In some embodiments, the cellulosic material is at least partially dried in absence of an external source of heat.

In some embodiments of any one of the subject methods, the lime comprises calcium oxide and calcium hydroxide.

In some embodiments of any one of the subject methods, the binder material further comprises silica. In some embodiments of any one of the subject methods, a weight ratio of the silica (S) and the lime (L) is between about 1:1 and about 1:5 (S:L). In some embodiments of any one of the subject methods, a weight ratio of the silica (S) and the lime (L) is about 1:3 (S:L).

In some embodiments of any one of the subject methods, a weight ratio of the binder material (BM) to the cellulosic material (CM) is between about 1:10 and about 20:10 (BM:CM). In some embodiments, the weight ratio of the binder material (BM) to the cellulosic material (CM) is between about 7:10 and about 15:10 (BM:CM). In some embodiments, the weight ratio of the binder material (BM) to the cellulosic material (CM) is between about 1:10 and about 2:10.

In some embodiments of any one of the subject methods, the method further comprises exposing the mixture in (b) to an external stimulus to transform the binding material into a cementitious material. In some embodiments, the external stimulus comprises one or more members selected from the group consisting of: carbonation, hydration, pressure, and heat. In some embodiments, the external stimulus comprises hydration. In some embodiments, the cementitious material comprise silicate.

In some embodiments of any one of the subject methods, the cellulosic material comprises one or more members selected from the group consisting of: a bast fiber, leaf, seed, fruit, grass, and wood. In some embodiments of any one of the subject methods, the cellulosic material comprises a hemp bast fiber.

In some embodiments of any one of the subject methods, the composite material is characterized by having a density between about 1 pounds per cubic foot (lb/ft³) and about 100 lbs/ft³. In some embodiments of any one of the subject methods, the composite material is characterized by having a density between about 1 lb/ft³ and about 30 lbs/ft³. In some embodiments of any one of the subject methods, the composite material has a density between about 5 lb/ft³ and 25 lb/ft³. In some embodiments of any one of the subject methods, the composite material is characterized by having a density of at least about 5 lbs/ft³.

In some embodiments of any one of the subject methods, the composite material is usable as a thermal or acoustic insulator for a building.

In some embodiments of any one of the subject methods, the composite material exhibits a biocidal activity against a microorganism.

In some embodiments of any one of the subject methods, the cellulosic material exhibits enhanced shelf-life as compared to a cellulosic material that does not exhibit the characterization.

Another aspect of the present disclosure provides a composite building material, wherein the cellulosic material (i) is at least partially delignified, (ii) maintains at least a portion of cellulose crystal structure, and (iii) comprises a plurality of pores, and wherein the cellulosic material is physically or chemically bound to (or within) a binding matrix.

In some embodiments, the cellulosic material is a natural fiber, optionally wherein the natural fiber comprises a bast fiber, leaf, seed, fruit, grass, or wood.

In some embodiments of any one of the subject composite building materials, a source of the cellulosic material is selected group the group consisting of flax, hemp, kenaf, jute, ramie, isora, nettle, ananas, sisal, abaca, curua, cabuya, palm, opuntia, jipijapa, yucca, cotton, coir, kapok, soya, poplar, calotropis, luffa, bamboo, totora, hardwood, softwood, and a combination thereof.

In some embodiments of any one of the subject composite building materials, the binding matrix is an inorganic binding matrix.

In some embodiments of any one of the subject composite building materials, the binding matrix comprises a cementitious material comprising cementitious oxides or hydroxides. In some embodiments, the cementitious material is formed (e.g., cured) by exposure to an external stimulus, optionally wherein the external stimulus comprises carbonation or hydration. In some embodiments, the cementitious material is formed from akali-activated materials.

In some embodiments of any one of the subject composite building materials, the binding matrix comprises lime (calcium oxide or calcium hydroxide) and silica (e.g., amorphous silica).

In some embodiments of any one of the subject composite building materials, the binding matrix comprises inorganic polymers or geopolymer cements, optionally wherein the geopolymer cement comprises (i) slag-based, rock-based, or alkali-activated fly ash geopolymer, (ii) slag/fly ash-based geopolymer cement, or (iii) ferro-sialate-based geopolymer cement.

In some embodiments of any one of the subject composite building materials, the binding matrix is blended with a volumetric portion of pozzolanic materials, porous ceramic aggregates, or other binding agents that form porous hydrates.

In some embodiments of any one of the subject composite building materials, the binding matrix is combined with a concrete admixture comprising foaming agents, blowing agents, or stearate gelling agents.

In some embodiments of any one of the subject composite building materials, the binding matrix comprises amorphous silica and/or calcium, aluminum, or magnesium silicates.

In some embodiments of any one of the subject composite building materials, the binding matrix exhibits an antibacterial and antifungal activity, optionally wherein the antibacterial and antifungal activity is demonstrated in an alkaline environment ranging between about pH 10 to about pH 14.

In some embodiments of any one of the subject composite building materials, the composite building material has a density between about 1 pounds per cubic foot (lb/ft³) and about 100 lbs/ft³. In some embodiments, the composite building material has a density between about 3 lb/ft³ and about 50 lbs/ft³. In some embodiments, the composite building material has a density between about 5 lb/ft³ and about 50 lbs/ft³. In some embodiments, the composite building material has a density between about 3.7 lb/ft³ and about 22 lbs/ft³. In some embodiments, the composite building material has a density between about 10 lb/ft³ and about 20 lbs/ft³.

In some embodiments of any one of the subject composite building materials, the composite building material has a density of at least about 5 lb/ft³.

In some embodiments of any one of the subject composite building materials, the composite building material is cured at a temperature between about 30 degrees Freethought (°F) and about 500° F. In some embodiments, the composite building material is cured at a temperature between about 40° F. and about 200° F. In some embodiments, the composite building material is cured at a temperature between about 60° F. and about 100° F.

In some embodiments of any one of the subject composite building materials, the composite building material is cured at a relative humidity of between about 50% to about 100%, to control binding matrix reaction (e.g., hydrate formation) and increase initial and long-term compressive strength. In some embodiments, the composite building material is cured at a relative humidity of between about 60% to about 99%, to control binding matrix reaction (e.g., hydrate formation) and increase initial and long-term compressive strength.

In some embodiments of any one of the subject composite building materials, the composite building material is cured in a controlled environmental (e.g., aforementioned) for between about 1 day to about 50 days. In some embodiments, the composite building material is cured in a controlled environment for between about 3 days to about 28 days.

In some embodiments of any one of the subject composite building materials, wherein a volumetric mix ratio of the cellulosic material (CM) and the binding matrix (BM) is between about 1:1 and about 10:1 (CM:BM).

In some embodiments of any one of the subject composite building materials, the composite building material is mixed in a drum, paddle, or pan mixture (e.g., a drum, paddle, or pan mixer for concrete or mortar). In some embodiments of any one of the subject composite building materials, the composite building material is cast into place, precast molded into place, or continuously extruded into place through ceramic vacuum or vibration extrusion manufacturing equipment.

In some embodiments of any one of the subject composite building materials, the composite building material exhibits thermal mass due to favorable hygroscopic pores that experience cyclic water vapor condensation and evaporation reactions.

Another aspect of the present disclosure provides a method for generating engineered fiber aggregates for composite building material, comprising subjecting a cellulosic material to a pretreatment such that the cellulosic material (i) is at least partially delignified, (ii) maintains at least a portion of cellulose crystal structure, and (iii) comprises a plurality of pores, to generate the engineered fiber aggregates.

In some embodiments, the pretreatment comprises selectively depolymerizing the cellulosic material by using liquid pulping or bleaching. In some embodiments, the bleaching effects increased surface area or surface roughness of the cellulosic material. In some embodiments, the increased surface area or surface roughness of the cellulosic material is capable of enhancing an increase in chemical or physical coupling (e.g., bonding) between the engineered fiber aggregates and a binder matrix.

In some embodiments of any one of the subject methods, the pretreatment (e.g., the selective depolymerization by liquid puling or bleaching) removes, from the cellulosic material, one or more members selected from the group consisting of free lipids, fats, oils, sugars such as hemicellulose, lignin, active molecules, inert molecules, and other contaminants capable of inhibiting chemical or physical bonding between the engineered fiber aggregates and a binding matrix.

In some embodiments of any one of the subject methods, the pretreatment (e.g., the selective depolymerization by liquid puling or bleaching) removes, from the cellulosic material, dust particles (i) capable of inhibiting chemical or physical bonding between the engineered fiber aggregates and a binding matrix or (ii) having a size less than or equal to about 1 millimeter.

In some embodiments of any one of the subject methods, the pretreatment (e.g., the selective depolymerization by liquid puling or bleaching) enhances shelf-life of the engineered fiber aggregates as compared to without the pretreatment.

In some embodiments of any one of the subject methods, the pretreatment (e.g., the selective depolymerization by liquid puling or bleaching) reduces or inhibits (e.g., neutralizes) bacterial or fungal growth on the engineered fiber aggregates as compared to without the pretreatment.

In some embodiments of any one of the subject methods, further comprising dewatering the cellulosic material or the engineered fiber aggregates to an ambient water weight (e.g., between about 4 and about 12% by weight). In some embodiments, dewatering is performed mechanically to avoid thermal energy input. In some embodiments, the mechanical dewatering comprises screw-pressing or centrifugal methods. In some embodiments, the mechanical dewatering avoids shrinkage of a cell wall of the cellulosic material or rupturing of the cell well as compared to a thermal dewatering mechanism.

In some embodiments of any one of the subject methods, the engineered fiber aggregates exhibit increased porosity as determined by mercury intrusion porosimetry. In some embodiments, the increased porosity is based at least in part on one or more dewatering mechanisms.

In some embodiments of any one of the subject methods, wherein the pretreatment reduces an amount of pores having a size greater than at least about 1 micrometer. In some embodiments of any one of the subject methods, wherein the pretreatment reduces an amount of pores having a size greater than at least about 10 micrometers. In some embodiments of any one of the subject methods, wherein the pretreatment reduces an amount of pores having a size greater than at least about 20 micrometers.

In some embodiments of any one of the subject methods, wherein the pretreatment reduces an amount of pores having a size of at least about 1 micrometer as compared to without the pretreatment. In some embodiments of any one of the subject methods, wherein the pretreatment reduces an amount of pores having a size of at least about 10 micrometers as compared to without the pretreatment. In some embodiments of any one of the subject methods, wherein the pretreatment reduces an amount of pores having a size of at least about 20 micrometers as compared to without the pretreatment.

In some embodiments of any one of the subject methods, wherein the pretreatment increases an amount of pores having a size of at most about 20 micrometers as compared to without the pretreatment In some embodiments of any one of the subject methods, wherein the pretreatment increases an amount of pores having a size of at most about 10 micrometers as compared to without the pretreatment. In some embodiments of any one of the subject methods, wherein the pretreatment increases an amount of pores having a size of at most about 1 micrometer as compared to without the pretreatment.

In some embodiments of any one of the subject methods, wherein the engineered fiber aggregates is characterized by exhibiting an increase in pores that reduce convection heat transfer due to the Knudsen effect.

In some embodiments of any one of the subject methods, further comprising mixing the engineered fiber aggregates with an additional material comprising one or more members selected from the group consisting of the cementitious binder, geopolymer binder, foaming agents, blowing agents, and stearate gelling agents. In some embodiments, the additional material is incorporated into at least a portion of the plurality of pores of the engineered fiber aggregates.

In some embodiments of any one of the subject methods, further comprising milling the engineered fiber aggregates to an average particle size between about 100 micrometers and about 100 millimeters. In some embodiments of any one of the subject methods, further comprising milling the engineered fiber aggregates to an average particle size between about 1 micrometers and about 100 millimeters. In some embodiments of any one of the subject methods, further comprising milling the engineered fiber aggregates to an average particle size between about 1 micrometers and about 51 millimeters.

In some embodiments of any one of the subject methods, the engineered fiber aggregates exhibit enhanced hygroscopic property as compared to without the pretreatment, wherein the hygroscopic property is characterized by (i) enhanced wicking or uptake of ambient water vapor or (ii) enhanced evaporation thereof upon an exposure to heat.

In some embodiments of any one of the subject methods, the engineered fiber aggregates exhibit enhanced thermal mass properties (e.g., thermal capacitance or heat capacity) as compared to without the pretreatment. In some embodiments of any one of the subject methods, the engineered fiber aggregates exhibit a thermal mass of between about 500 Joule per kilogram per kelvin (J/kg·K) and about 2500 J/kg·K. In some embodiments of any one of the subject methods, the engineered fiber aggregates exhibit a thermal mass of between about 1000 J/kg·K to about 2100 J/kg·K.

In some embodiments of any one of the subject methods, the engineered fiber aggregates have a density (e.g., a dry-bulk density) of less than or equal to about 1000 kilogram per cubic meter (kg/m³) (or 62 lbs/ft³). In some embodiments, the engineered fiber aggregates have a density of less than or equal to about 500 kg/m³ (or 31 lbs/ft³). In some embodiments, the engineered fiber aggregates have a density of less than or equal to about 300 kg/m³ (or 19 lbs/ft³).

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is int'ended to supersede and/or take precedence over any such contradictory material.

### BRIEF DESCRIPTION OF THE DRAWINGS

The novel features of the invention are set forth with particularity in the appended claims. A better understanding of the features and advantages of the present disclosure will be obtained by reference to the following detailed description that sets forth illustrative embodiments, in which the principles of the invention are utilized, and the accompanying drawings (also “Figure” and “FIG.” herein) of which:

FIG. 1 shows mercury intrusion porosimetry data of a cellulosic material that is treated with various drying methods.

FIG. 2 shows a scanning electron microscopy (SEM) image of a cellulosic material following delignification.

FIG. 3 shows an SEM image of another cellulosic material following delignification.

FIG. 4 shows an example composite material comprising a cellulosic material and a binder material.

FIG. 5 shows an example flowchart of a method for generating a composite material.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The present disclosure provides compositions and methods for a composite material, e.g., to be used in residential and/or commercial buildings. In an aspect, the present disclosure provides a composite material (e.g., a composite building material). The composite material may include a cellulosic material. The cellulosic material may be (i) at least partially delignified, (ii) maintains at least a portion of cellulose crystal structure, and/or (iii) comprises a plurality of pores. The composite material may include an additional material (e.g., a fire retardant) coupled to the cellulosic material. In some cases, the additional material may be distributed in and/or on the cellulosic material. In some cases, one or more of the plurality of pores may be covered by the additional material. In some examples, the composite building material may be used as thermal and acoustic insulators. In another aspect, the present disclosure provides methods of manufacturing the composite material as disclosed herein. In another aspect, the present disclosure provides methods for preparing the cellulosic material to be used for the composite material.

The additional material may be a binder material (or binding material, as used interchangeably herein). In some cases, the binder material may comprise lime, such as calcium oxide and/or calcium hydroxide. In some cases, the binder material may comprise silica. Lime and silica may be exposed to an external stimulus (e.g., carbonation, hydration, pressure, and heat) to react to form a cementitious material, e.g., calcium silicate hydrate (C-S-H). In some cases, the binder material may be the cementitious material, such as C-S-H.

In some cases, lime can comprise quicklime. A quicklime can be high calcium quicklime comprising at most about 10% by weight, at most about 5% by weight, at most about 2% by weight, at most about 1% by weight, at most about 0.5% by weight, at most about 0.2% by weight, at most about 0.1% by weight, or less of magnesium carbonate. A quicklime can be magnesian quicklime comprising between about 5% to about 35% by weight of magnesium carbonate. A quicklime can be dolomitic quicklime comprising between about 35% to about 45% by weight of magnesium carbonate.

In some cases, the can be hydrated lime. The hydrated lime can be high calcium hydrated lime comprising at least or up to about 60% by weight, at least or up to about 65% by weight, at least or up to about 70% by weight, at least or up to about 75% by weight, at least or up to about 80% by weight, at least or up to about 85% by weight, or at least or up to about 90% by weight of calcium oxide or calcium hydroxide. The hydrated lime can be dolomitic hydrated lime comprising (1) at least or up to about 30% by weight, at least or up to about 35% by weight, at least or up to about 40% by weight, at least or up to about 45% by weight, at least or up to about 50% by weight, at least or up to about 55% by weight, or at least or up to about 60% by weight of calcium oxide or calcium hydroxide and (2) at least or up to about 5% by weight, at least or up to about 10% by weight, at least or up to about 15% by weight, or at least or up to about 20% by weight of magnesium oxide.

In some cases, lime can be a fine powder. Alternatively or in addition to, lime can be a slurry.

In some cases, lime can be Type N lime (i.e., normal hydrated lime). In some cases, lime can be Type NA lime (i.e., normal air-entraining hydrated lime). In some cases, lime can be Type S lime (i.e., special hydrated lime). In some cases, lime can be Type SA lime (i.e., special air-entraining hydrated lime).

In some cases, lime as provided herein can comprise one or more members selected from the group consisting of: American Society for Testing and Materials (ASTM) C977, ASTM C593, ASTM D6276, ASTM D5102, ASTM C1097, ASTM D4867, ASTM C1529, ASTM D6249, ASTM C400, ASTM C1318, ASTM C207, ASTM C206, ASTM C821, ASTM C5, ASTM C270, ASTM C911, ASTM D5050, ASTM E1266, ASTM C602, ASTM C25, ASTM C110, ASTM C1271, ASTM C1301, ASTM C50, and ASTM C50.

In some cases, the silica may be a part of a non-cementitious material (e.g., a pozzolan material) that is capable of forming a cementitious material upon reaction (e.g., a chemical reaction with lime). The pozzolanic material may be natural or synthetic. Non-limiting examples of the pozzolanic material may include fly ash, silica fume from silicon smelting, highly reactive metakaolin, burned organic matter residues rich in silica such as rice husk ash, and pumice.

In some cases, the binder material may further comprise silicate particles, such as silicate nanoparticles (e.g., nanocrystals) and/or microparticles (e.g., microcrystals). In some examples, the silicate particles may comprise C-S-H nanoparticles and/or microparticles. The CS-H nanoparticles may provide nucleation sites during the reaction of the binder material to form a larger-scale cementitious material, such as C-S-H. During the nucleation and growth kinetic cycle of new C-S-H formation, the pre-loaded C-S-H nanoparticles may lower the activation energy required of the new C-S-H formation. In some embodiments, a silicate comprises aluminosilicates. In some embodiments, an aluminosilicate comprises one or more of andalusite, kyanite, and sillimanite.

In some cases, a weight ratio of the silica (S) and the lime (L) in the composite material may be between about 20:1 to about 1:20 (S:L). The weight ratio of the silica and the lime (S:L) in the composite material may be between about 10:1 to about 1:10, between about 5:1 to about 1:5, between about 2:1 to about 1:5, between about 1:1 to about 1:5, or between about 1:1 to about 1:4.

In some cases, the weight ratio of the silica and the lime (S:L) in the composite material may be at least or up to about 20:1, at least or up to about 19:1, at least or up to about 18:1, at least or up to about 17:1, at least or up to about 16:1, at least or up to about 15:1, at least or up to about 14:1, at least or up to about 13:1, at least or up to about 12:1, at least or up to about 11:1, at least or up to about 10:1, at least or up to about 9:1, at least or up to about 8:1, at least or up to about 7:1, at least or up to about 6:1, at least or up to about 5:1, at least or up to about 4:1, at least or up to about 3:1, at least or up to about 2:1, at least or up to about 1:1, at least or up to about 1:2, at least or up to about 1:3, at least or up to about 1:4, at least or up to about 1:5, at least or up to about 1:6, at least or up to about 1:7, at least or up to about 1:8, at least or up to about 1:9, at least or up to about 1:10, at least or up to about 1:11, at least or up to about 1:12, at least or up to about 1:13, at least or up to about 1:14, at least or up to about 1:15, at least or up to about 1:16, at least or up to about 1:17, at least or up to about 1:18, at least or up to about 1:1, or at least or up to about 1:20. In an example, the weight ratio of the silica and the lime (S:L) in the composite material may be about 1:3.

In some cases, a weight ratio of the additional material (AM) to the cellulosic material (CM) in the composite material may be between about 1:10 to about 50:10 (AM:CM). The weight ratio of the additional material to the cellulosic material (AM:CM) in the composite material may be between about 1:10 to about 45:10, between about 1:10 to about 40:10, between about 1:10 to about 35:10, between about 1:10 to about 35:10, between about 1:10 to about 30:10, between about 1:10 to about 25:10, between about 1:10 to about 20:10, between about 1:10 to about 15:10, between about 1:10 to about 10:10, or between about 1:10 to about 5:10. In some cases, the weight ratio of the additional material to the cellulosic material (AM:CM) in the composite material may be between about 1:10 to about 20:10, between about 5:10 to about 20:10, or between about 5:10 to about 15:10.

In some cases, the weight ratio of the additional material to the cellulosic material (AM:CM) in the composite material may be at least or up to about 100:10, at least or up to about 50:10, at least or up to about 45:10, at least or up to about 40:10, at least or up to about 35:10, at least or up to about 30:10, at least or up to about 25:10, at least or up to about 20:10, at least or up to about 19:10, at least or up to about 18:10, at least or up to about 17:10, at least or up to about 16:10, at least or up to about 15:10, at least or up to about 14:10, at least or up to about 13:10, at least or up to about 12:10, at least or up to about 11:10, at least or up to about 10:10, at least or up to about 9:10, at least or up to about 8:10, at least or up to about 7:10, at least or up to about 6:10, at least or up to about 5:10, at least or up to about 4:10, at least or up to about 3:10, at least or up to about 2:10, at least or up to about 1:10, at least or up to about 2:10, at least or up to about 3:10, at least or up to about 4:10, at least or up to about 5:10, at least or up to about 6:10, at least or up to about 7:10, at least or up to about 8:10, at least or up to about 9:10, at least or up to about 10:10, at least or up to about 11:10, at least or up to about 12:10, at least or up to about 13:10, at least or up to about 14:10, at least or up to about 15:10, at least or up to about 16:10, at least or up to about 17:10, at least or up to about 18:10, at least or up to about 19:10, at least or up to about 20:10, at least or up to about 25:10, at least or up to about 30:10, at least or up to about 35:10, at least or up to about 40:10, at least or up to about 45:10, at least or up to about 50:10, or at least or up to about 100:10.

In some cases, a weight ratio of the binder material (BM) to the cellulosic material (CM) in the composite material may be between about 1:10 to about 50:10 (BM:CM). The weight ratio of the binder material to the cellulosic material (BM:CM) in the composite material may be between about 1:10 to about 45:10, between about 1:10 to about 40:10, between about 1:10 to about 35:10, between about 1:10 to about 35:10, between about 1:10 to about 30:10, between about 1:10 to about 25:10, between about 1:10 to about 20:10, between about 1:10 to about 15:10, between about 1:10 to about 10:10, between about 1:10 to about 9:10, between about 1:10 to about 8:10, between about 1:10 to about 7:10, between about 1:10 to about 6:10, between about 1:10 to about 5:10, between about 1:10 to about 4:10, between about 1:10 to about 3:10, or between about 1:10 to about 2:10. In some cases, the weight ratio of the additional material to the cellulosic material (AM:CM) in the composite material may be between about 1:10 to about 20:10, between about 5:10 to about 20:10, or between about 5:10 to about 15:10.

In some cases, the weight ratio of the binder material to the cellulosic material (BM:CM) in the composite material may be at least or up to about 100:10, at least or up to about 50:10, at least or up to about 45:10, at least or up to about 40:10, at least or up to about 35:10, at least or up to about 30:10, at least or up to about 25:10, at least or up to about 20:10, at least or up to about 19:10, at least or up to about 18:10, at least or up to about 17:10, at least or up to about 16:10, at least or up to about 15:10, at least or up to about 14:10, at least or up to about 13:10, at least or up to about 12:10, at least or up to about 11:10, at least or up to about 10:10, at least or up to about 9:10, at least or up to about 8:10, at least or up to about 7:10, at least or up to about 6:10, at least or up to about 5:10, at least or up to about 4:10, at least or up to about 3:10, at least or up to about 2:10, at least or up to about 1:10, at least or up to about 2:10, at least or up to about 3:10, at least or up to about 4:10, at least or up to about 5:10, at least or up to about 6:10, at least or up to about 7:10, at least or up to about 8:10, at least or up to about 9:10, at least or up to about 10:10, at least or up to about 11:10, at least or up to about 12:10, at least or up to about 13:10, at least or up to about 14:10, at least or up to about 15:10, at least or up to about 16:10, at least or up to about 17:10, at least or up to about 18:10, at least or up to about 19:10, at least or up to about 20:10, at least or up to about 25:10, at least or up to about 30:10, at least or up to about 35:10, at least or up to about 40:10, at least or up to about 45:10, at least or up to about 50:10, or at least or up to about 100:10.

In some cases, the composite material may have a density (e.g., a bulk density) between about 1 pounds per cubic foot (lb/ft³) and about 100 lbs/ft³. The composite material may have a density between about 1 lb/ft³ and about 100 lbs/ft³, between about 1 lb/ft³ and about 90 lbs/ft³, between about 1 lb/ft³ and about 80 lbs/ft³, between about 1 lb/ft³ and about 70 lbs/ft³, between about 1 lb/ft³ and about 60 lbs/ft³, between about 1 lb/ft³ and about 50 lbs/ft³, between about 1 lb/ft³ and about 40 lbs/ft³, between about 1 lb/ft³ and about 35 lbs/ft³, between about 1 lb/ft³ and about 30 lbs/ft³, between about 1 lb/ft³ and about 25 lbs/ft³, between about 1 lb/ft³ and about 20 lbs/ft³, between about 1 lb/ft³ and about 15 lbs/ft³, between about 1 lb/ft³ and about 10 lbs/ft³, or between about 1 lb/ft³ and about 5 lbs/ft³.

In some cases, the composite material may have a density of at least or up to about 0.1 lbs/ft³, at least or up to about 0.5 lbs/ft³, at least or up to about 1 lbs/ft³, at least or up to about 2 lbs/ft³, at least or up to about 3 lbs/ft³, at least or up to about 4 lbs/ft³, at least or up to about 5 lbs/ft³, at least or up to about 6 lbs/ft³, at least or up to about 7 lbs/ft3, at least or up to about 8 lbs/ft³, at least or up to about 9 lbs/ft³, at least or up to about 10 lbs/ft³, at least or up to about 11 lbs/ft³, at least or up to about 12 lbs/ft³, at least or up to about 13 lbs/ft³, at least or up to about 14 lbs/ft³, at least or up to about 15 lbs/ft³, at least or up to about 20 lbs/ft³, at least or up to about 25 lbs/ft³, at least or up to about 30 lbs/ft³, at least or up to about 35 lbs/ft³, at least or up to about 40 lbs/ft³, at least or up to about 45 lbs/ft³, at least or up to about 50 lbs/ft³, or at least or up to about 100 lbs/ft³.

In some cases, the composite material may exhibit enhanced shelf-life as compared to a control material. The control material may be a composite material with the cellulosic material exhibiting one or more characterizations of (i) through (iii). The shelf-life of the composite material may be greater than that of the control material by at least or up to 0.1-fold, at least or up to 0.2-fold, at least or up to 0.3-fold, at least or up to 0.4-fold, at least or up to 0.5-fold, at least or up to 0.6-fold, at least or up to 0.7-fold, at least or up to 0.8-fold, at least or up to 0.9-fold, at least or up to 1-fold, at least or up to 2-fold, at least or up to 3-fold, at least or up to 4-fold, at least or up to 5-fold, at least or up to 10-fold, at least or up to 15-fold, at least or up to 20-fold, at least or up to 25-fold, at least or up to 30-fold, at least or up to 35-fold, at least or up to 40-fold, at least or up to 45-fold, at least or up to 50-fold, at least or up to 60-fold, at least or up to 70-fold, at least or up to 80-fold, at least or up to 90-fold, or at least or up to 100-fold.

In some cases, the composite material provide an antibacterial or antifungal environment. In some cases, the composite material may exhibit a biocidal activity against a microorganism. The microorganism can comprise a fungus (e.g., mushrooms, mold, and/or yeast), a bacteria, and/or a virus. Non-limiting examples of a fungus include Absidia, Acremonium, Agaricus, Anaeromyces, Aspergillus, Aeurobasidium, Cephalosporum, Chaetomium, Coprinus, Dactyllum, Fusarium, Gliocladium, Humicola, Mucor, Neurospora, Neocallimastix, Orpinomyces, Penicillium, Phanerochaete, Phlebia, Piromyces, Pseudomonas, Rhizopus, Schizophyllum, Trametes, and Zygorhynchus. Non-limiting examples of a bacteria include gram-positive bacteria (e.g., Staphylococcus, Micrococcus, Bacillus, Propionibacterium) and gram-negative bacteria (e.g., Pseudomonas, Serratia, Burkholderia, Legionella).

In some cases, the composite material may exhibit a biocidal activity against one or more species of a microorganism. The composite material can exhibit a biocidal activity against at least or up to 1 species, at least or up to 2 species, at least or up to 3 species, at least or up to 4 species, at least or up to 5 species, at least or up to 6 species, at least or up to 7 species, at least or up to 8 species, at least or up to 9 species, at least or up to 10 species, at least or up to 11 species, at least or up to 12 species, at least or up to 13 species, at least or up to 14 species, at least or up to 15 species, at least or up to 16 species, at least or up to 17 species, at least or up to 18 species, at least or up to 19 species, at least or up to 20 species of a microorganism.

In some cases, the composite material may exhibit a biocidal activity against a microorganism for at least or up to 1 hour, at least or up to 2 hours, at least or up to 4 hours, at least or up to 6 hours, at least or up to 12 hours, at least or up to 18 hours, at least or up to 24 hours, at least or up to 2 days, at least or up to 3 days, at least or up to 4 days, at least or up to 5 days, at least or up to 6 days, at least or up to 7 days, at least or up to 2 weeks, at least or up to 3 weeks, at least or up to 4 weeks, at least or up to 2 months, at least or up to 3 months, at least or up to 4 months, at least or up to 5 months, at least or up to 6 months, at least or up to 7 months, at least or up to 8 months, at least or up to 9 months, at least or up to 10 months, at least or up to 11 months, at least or up to 12 months, at least or up to 2 years, at least or up to 3 years, at least or up to 4 years, at least or up to 5 years, or at least or up to 10 years.

In some cases, the composite material may exhibit enhanced biocidal activity as compared to a control material. The control material may be a composite material with the cellulosic material exhibiting one or more characterizations of (i) through (iii). The biocidal activity of the composite material may be greater than that of the control material by at least or up to 0.1-fold, at least or up to 0.2-fold, at least or up to 0.3-fold, at least or up to 0.4-fold, at least or up to 0.5-fold, at least or up to 0.6-fold, at least or up to 0.7-fold, at least or up to 0.8-fold, at least or up to 0.9-fold, at least or up to 1-fold, at least or up to 2-fold, at least or up to 3-fold, at least or up to 4-fold, at least or up to 5-fold, at least or up to 10-fold, at least or up to 15-fold, at least or up to 20-fold, at least or up to 25-fold, at least or up to 30-fold, at least or up to 35-fold, at least or up to 40-fold, at least or up to 45-fold, at least or up to 50-fold, at least or up to 60-fold, at least or up to 70-fold, at least or up to 80-fold, at least or up to 90-fold, or at least or up to 100-fold.

In some cases, the cellular material (e.g., cellulose aggregate) may be coupled to the binder material (e.g., inorganic cementitious matrix or precursors thereof) via chemical and/or dispersive adhesion. Chemical adhesion may be achieved by covalent, ionic, and/or hydrogen bonding. Dispersive adhesion may be achieved by, e.g., Van der Waals forces.

In some cases, the binder material may comprise Calcium Oxide, Aluminum Oxide, Iron Oxide (e.g., Fe2O3, Fe3O4, FeO (OH), FeO, etc.), Sodium Oxide, Potassium Oxide, Nickel Oxide, Magnesium Oxide, Zinc Oxide, modifications thereof (e.g., varying oxidation numbers), or combinations thereof.

In some cases, the binder material may comprise cementitious hydroxides comprising Silicon Dioxide, Titanium Dioxide, Carbon Dioxide, Sulfur Trioxide, Phosphorous hemi-pentoxide, Calcium Sulfate Dihydrate (i.e., Gypsum). modifications thereof, or combinations thereof.

In some cases, the binder material may comprise at least two components (e.g., lime and silica), and the at least two components may be exposed to an external stimulus (e.g., carbonation, hydration, pressure, and heat) to transform the at least two components into a binder matrix. For example, carbonation (Ca(OH)2 + CO2 - CaCO3 + H2O) process may be performed via diffusion of CO2 to a reaction site (e.g., at least a portion of the composite material) to form calcium carbonates. In another example, hydration (Ca(OH)2 + SiO2 - xCaO.ySiO2.zH2O) process may be performed to form C-S-H. The hydration process may be regulated by controlling reaction variables, such as, for example, time, temperature, pH, and chemical composition of the reactants (e.g., lime and silica). In some examples, the hydration reaction may occur uniformly throughout the composite material. In some examples, the hydration reaction may not and need not occur uniformly throughout the composite material. In some cases, the hydration process may last at least or up to about 1 day, at least or up to about 2 days, at least or up to about 3 days, at least or up to about 4, at least or up to about 5, at least or up to about 6, at least or up to about 7, at least or up to about 1 week, at least or up to about 2 weeks, at least or up to about 3 weeks, at least or up to about 4 weeks, at least or up to about 2 months, at least or up to about 3 months, at least or up to about 4 months, or at least or up to about 5 months. Without wishing to be bound by theory, in some cases, a limiting factor of the hydration process disclosed herein may be the dissolution of silica.

In some cases, calcium oxide may not undergo a hydration process (or a hydraulic setting reaction). In some cases, the methods disclosed herein may rely on carbonation hardening reactions. For example, pozzolanic oxides/hydroxides (e.g., siliceous, siliceous, or aluminous materials) may be added to the cellulosic material to induce hydraulic setting mechanisms in order to increase initial strength and overall strength, e.g., primarily compressive strength.

In some cases, components of the additional material disclosed herein may be subjected to geopolymerization to form a binder material. Geopolymerization may involve chemical reaction of oxides (e.g., alumina-silicate oxides) with silicates (e.g., alkali polysilicates) to yield polymeric Si-O-Al materials. For example, the polymeric Si-O-Al material may include amorphous or semicrystalline silico-aluminate structures, such as Poly(sialate) type (e.g., comprising the -Si-O-Al-O-bond), Poly(sialate-siloxo) type (e.g., comprising the -Si-O-Al-O-Si-O- bond), and the Poly(sialate-disiloxo) type (e.g., comprising the -Si-O-Al-O-Si-O-Si-O- bond).

In some cases, the additional material may be a binder material comprising poly(ferro-sialate), e.g., comprising the (Ca,K)-(-Fe-O)-(Si-O-Al-O-) bond. In some cases, a number of cationic metallic ions or oxides may be bound to the sialate monomers that form long polymer chains. As for the example of poly(ferro-sialate), there may be a calcium, sodium, or potassium ion bound to ferrous oxide within the individual monomers.

In some cases, the additional material may comprise one or more admixtures (e.g., concrete admixtures). The admixture(s) may comprise one or members selected form the group consisting of: foaming agents, blowing agents, and stearate gelling agents. In some cases, the additional material may comprise hydrate crystals and/or plasticizer agents (e.g., superplasticizer agents). Such additional material may exhibit high surface area.

In some examples, high surface area hydrate crystals may be nanoscale crystals that can act as seeding agents to reduce the activation energy for nucleation, growth, ultimately crystallization of hydrates (e.g., C-S.H). The seeding agents may share identical chemistry to the type of hydrates that will be formed by the binding matrix. For example, a cementitious binding matrix that forms C-S-H hydrates may be dosed with nanoscale C-S-H crystals. These nanocrystals may be added during the slurry mixing phase (e.g., the mixture comprising the cellulosic material with the binder material as disclosed herein) with a typical dosage of between about 280 to about 1000 milliliters (mL) per 100 kilograms (kg) of the cementitious binder material. The use of the hydrate nanocrystals may increase the initial rate of hydration reaction (e.g., 24 hour compressive strength) and/or quality of the final cured hydration state (e.g., 28 day compressive strength).

In some examples, superplasticizer and plasticizer agents may be added to reduce the amount of water required to maintain workability in a cementitious slurry (e.g., the mixture comprising the cellulosic material and the binder material). Plasticizers may reduce the water content up to about 15 weight %, and superplasticizers may reduce the water content up to about 40 weight %. Reducing the water to cement ratio of the slurry may lead to higher compressive strengths. Cellulose fibers may reduce the workability of cementitious slurries upon mixing because of the significant water absorption of the cellulose fibers, thus limiting the amount of free water within the slurry itself. Thus, superplasticizers may act as dispersants to reduce the particle size of concrete molecules, which in turn, may increase their surface area to making them easier to wet. In an example, superplasticizers capable of creating concrete dispersion through steric hindrance rather than electrostatic repulsion may be used. A non-limiting example of a plasticizer may include polysulfonate. A non-limiting example of a superplasticizer may include polycarboxylate.

In some embodiments of the present disclosure, the additional material (e.g., the binder material that are precursors of a binder matrix) may be treated (e.g., cured) to form a binder matrix, thereby forming a composite material comprising the cellulosic material and the binder matrix. In some cases, cellulose fibers may have open cell anatomies and pore structures designed to uptake and release water vapor effectively (i.e., vapor wicking). The cellulose fibers may experiences cyclic water vapor condensation and evaporation reactions passively in hot or humid environments via vapor drive. In some cases, the cellulose fiber of the present disclosure may be vapor permeable to allow for such vapor drive to occur throughout its cross sectional area. Vapor drive may force water vapor from the hot boundary of the cellulosic material (or the composite material) to the cold boundary. As water vapor travels from the hot boundary through the material, the water vapor may cool down and condense to liquid water within pores (e.g., nanopores and/or micropores) within the material. Condensation may be an exothermic reaction that loses energy in the form of heat. As temperatures and vapor pressure change within the pores, the liquid water may evaporate in an endothermic reaction which results in the water absorbing energy in the form of heat to return to the vapor phase. The described mechanisms herein may produce a type of thermal mass phenomenon akin to the effects of phase change materials being implemented in building systems. Thus, in some cases, the cellulosic material (and thus the composite material) disclosed herein may be capable of wicking water vapor at a rate that effectively mimics thermal mass because of the highly specific pore size distribution within the cellulosic material (e.g., fiber aggregates) and binder material (e.g., binder matrix).

In some cases, the cellulosic material disclosed herein is pretreated to reduce an amount of pores having a size greater than a threshold value (e.g., 10 micrometer). The removal of some of the larger pores having a size greater than the threshold value may allow for enhanced water wicking properties by the cellulosic material. Pores that are too large may collect too much water condensation, and begin to pool within the pores rather than discharge the water in the form of evaporation. The cyclic condensation to evaporation process may be critical in storing and releasing energy within the material to experience beneficial thermal mass properties by storing and releasing heat.

0105] In some cases, the cellulosic material disclosed herein is pretreated to reduce an amount of pores having a size greater than at least about 0.1 micrometer, at least about 0.5 micrometer, at least about 1 micrometer, at least about 2 micrometer, at least about 3 micrometer, at least about 4 micrometer, at least about 5 micrometer, at least about 6 micrometer, at least about 7 micrometer, at least about 8 micrometer, at least about 9 micrometer, at least about 10 micrometer, at least about 15 micrometer, at least about 20 micrometer, at least about 25 micrometer, at least about 30 micrometer, at least about 35 micrometer, at least about 40 micrometer, at least about 45 micrometer, at least about 50 micrometer, or more as compared to a cellulosic material without the pretreatment. In some examples, the cellulosic material disclosed herein is pretreated to reduce an amount of pores having a size greater than at least about 10 micrometer as compared to a cellulosic material without the pretreatment.

In some embodiments, water content of the cellulosic material may be reduced (i.e., dewatered) mechanically, e.g., using pressure, such as screw press, or centrifugal force. In some cases, the water content of the cellulosic material may be reduced to an ambient water weight (e.g., between about 4% to about 12% by weight). A screw press may utilize torsional force by forcing wet fibers down a tube (e.g., a fixed diameter tube) with a screw (e.g., a large screw). There may be a mesh screen on the perimeter of the tube where water may be forced out of the wet fiber aggregates. Conditions such as the size of the tube, the size of the screw, a degree of the force applied, a volume of fiber input, and rotational speed of the spinning screw may regulate the rate at which water may be expelled from the wet fibers. A centrifugal dewatering machine may act in a similar manner. Wet fibers may be charged into a cylindrical drum with a mesh screen on the exterior perimeter. In some cases, filter bags may be included within the cylinder to keep the cellulosic fibers from being discharged through the mesh screen. The drum may spin at a rotational speed between about 100 rotations per minute (RPM) and about 2000 RPM, e.g., between about 500 RPM and about 1200 RPM. Centrifugal forces of the rotation may force the wet cellulosic fibers away from the center point towards the perimeter mesh screen. Thus, in some cases, the cellulosic material disclosed herein may be at least partially dried by an external pressure. The external pressure may be based on screw press and/or centrifugation.

The cellulosic material of the present disclosure may exhibit a heat capacity (e.g., as an indication of thermal mass) of at least or up to about 100 Joule per kilogram per kelvin (J/kg·K), at least or up to about 200 J/kg·K, at least or up to about 300 J/kg·K, at least or up to about 400 J/kg·K, at least or up to about 500 J/kg·K, at least or up to about 600 J/kg·K, at least or up to about 700 J/kg·K, at least or up to about 800 J/kg·K, at least or up to about 900 J/kg·K, at least or up to about 1000 J/kg·K, at least or up to about 1100 J/kg·K, at least or up to about 1200 J/kg·K, at least or up to about 1300 J/kg·K, at least or up to about 1400 J/kg·K, at least or up to about 1500 J/kg·K, at least or up to about 1600 J/kg·K, at least or up to about 1700 J/kg·K, at least or up to about 1800 J/kg·K, at least or up to about 1900 J/kg·K, at least or up to about 2000 J/kg·K, at least or up to about 2500 J/kg·K, at least or up to about 3000 J/kg·K, at least or up to about 3500 J/kg·K, at least or up to about 4000 J/kg·K, at least or up to about 4500 J/kg·K, at least or up to about 5000 J/kg·K, at least or up to about 6000 J/kg·K, at least or up to about 7000 J/kg·K, at least or up to about 8000 J/kg·K, at least or up to about 9000 J/kg·K, or at least or up to about 10000 J/kg·K.

The cellulosic material of the present disclosure may exhibit a heat capacity that is between about 500 J/kg·K and about 10000 J/kg·K, between about 500 J/kg·K to about 8000 J/kg·K, between about 500 J/kg·K and about 6000 J/kg·K, between about 1000 J/kg·K and about 5000 J/kg·K, or between about 1000 J/kg·K and about 4000 J/kg·K.

The composite material of the present disclosure may exhibit a heat capacity (e.g., as an indication of thermal mass) of at least or up to about 100 Joule per kilogram per kelvin (J/kg·K), at least or up to about 200 J/kg·K, at least or up to about 300 J/kg·K, at least or up to about 400 J/kg·K, at least or up to about 500 J/kg·K, at least or up to about 600 J/kg·K, at least or up to about 700 J/kg·K, at least or up to about 800 J/kg·K, at least or up to about 900 J/kg·K, at least or up to about 1000 J/kg·K, at least or up to about 1100 J/kg·K, at least or up to about 1200 J/kg·K, at least or up to about 1300 J/kg·K, at least or up to about 1400 J/kg·K, at least or up to about 1500 J/kg·K, at least or up to about 1600 J/kg·K, at least or up to about 1700 J/kg·K, at least or up to about 1800 J/kg·K, at least or up to about 1900 J/kg·K, at least or up to about 2000 J/kg·K, at least or up to about 2500 J/kg·K, at least or up to about 3000 J/kg·K, at least or up to about 3500 J/kg·K, at least or up to about 4000 J/kg·K, at least or up to about 4500 J/kg·K, at least or up to about 5000 J/kg·K, at least or up to about 6000 J/kg·K, at least or up to about 7000 J/kg·K, at least or up to about 8000 J/kg·K, at least or up to about 9000 J/kg·K, or at least or up to about 10000 J/kg·K.

The composite material of the present disclosure may exhibit a heat capacity that is between about 500 J/kg·K and about 10000 J/kg·K, between about 500 J/kg·K to about 8000 J/kg·K, between about 500 J/kg·K and about 6000 J/kg·K, between about 1000 J/kg·K and about 5000 J/kg·K, or between about 1000 J/kg·K and about 4000 J/kg·K.

The cellulosic material of the present disclosure may exhibit a thermal conductivity of at least or up to about 0.001 watts per meter-kelvin (W/(m•K)), at least or up to about 0.002 W/(m•K), at least or up to about 0.003 W/(m•K), at least or up to about 0.004 W/(m•K), at least or up to about 0.005 W/(m•K), at least or up to about 0.006 W/(m•K), at least or up to about 0.007 W/(m•K), at least or up to about 0.008 W/(m•K), at least or up to about 0.009 W/(m•K), at least or up to about 0.01 W/(m•K), at least or up to about 0.02 W/(m•K), at least or up to about 0.03 W/(m•K), at least or up to about 0.04 W/(m•K), at least or up to about 0.05 W/(m•K), at least or up to about 0.06 W/(m•K), at least or up to about 0.07 W/(m•K), at least or up to about 0.08 W/(m•K), at least or up to about 0.09 W/(m•K), at least or up to about 0.1 W/(m•K), at least or up to about 0.2 W/(m•K), at least or up to about 0.3 W/(m•K), at least or up to about 0.4 W/(m•K), at least or up to about 0.5 W/(m•K), at least or up to about 0.6 W/(m•K), at least or up to about 0.7 W/(m•K), at least or up to about 0.8 W/(m•K), at least or up to about 0.9 W/(m•K), at least or up to about 1.0 W/(m•K), at least or up to about 1.1 W/(m•K), at least or up to about 1.2 W/(m•K), at least or up to about 1.3 W/(m•K), at least or up to about 1.4 W/(m•K), at least or up to about 1.5 W/(m•K), at least or up to about 1.6 W/(m•K), at least or up to about 1.7 W/(m•K), at least or up to about 1.8 W/(m•K), at least or up to about 1.9 W/(m•K), at least or up to about 2 W/(m•K), at least or up to about 3 W/(m•K), at least or up to about 4 W/(m•K), at least or up to about 5 W/(m•K), at least or up to about 6 W/(m•K), at least or up to about 7 W/(m•K), at least or up to about 8 W/(m•K), at least or up to about 9 W/(m•K), or at least or up to about 10.

The cellulosic material of the present disclosure may exhibit a thermal conductivity that is between about 0.005 W/(m•K) and about 0.5 W/(m•K), between about 0.005 W/(m•K) and about 0.4 W/(m•K), between about 0.005 W/(m•K) and about 0.3 W/(m•K), between about 0.005 W/(m•K) and about 0.2 W/(m•K), between about 0.01 W/(m•K) and about 0.2 W/(m•K). or between about 0.01 W/(m•K) and about 0.16 W/(m•K).

The composite material of the present disclosure may exhibit a thermal conductivity of at least or up to about 0.001 watts per meter-kelvin (W/(m•K)), at least or up to about 0.002 W/(m•K), at least or up to about 0.003 W/(m•K), at least or up to about 0.004 W/(m•K), at least or up to about 0.005 W/(m•K), at least or up to about 0.006 W/(m•K), at least or up to about 0.007 W/(m•K), at least or up to about 0.008 W/(m•K), at least or up to about 0.009 W/(m•K), at least or up to about 0.01 W/(m•K), at least or up to about 0.02 W/(m•K), at least or up to about 0.03 W/(m•K), at least or up to about 0.04 W/(m•K), at least or up to about 0.05 W/(m•K), at least or up to about 0.06 W/(m•K), at least or up to about 0.07 W/(m•K), at least or up to about 0.08 W/(m•K), at least or up to about 0.09 W/(m•K), at least or up to about 0.1 W/(m•K), at least or up to about 0.2 W/(m•K), at least or up to about 0.3 W/(m•K), at least or up to about 0.4 W/(m•K), at least or up to about 0.5 W/(m•K), at least or up to about 0.6 W/(m•K), at least or up to about 0.7 W/(m•K), at least or up to about 0.8 W/(m•K), at least or up to about 0.9 W/(m•K), at least or up to about 1.0 W/(m•K), at least or up to about 1.1 W/(m•K), at least or up to about 1.2 W/(m•K), at least or up to about 1.3 W/(m•K), at least or up to about 1.4 W/(m•K), at least or up to about 1.5 W/(m•K), at least or up to about 1.6 W/(m•K), at least or up to about 1.7 W/(m•K), at least or up to about 1.8 W/(m•K), at least or up to about 1.9 W/(m•K), at least or up to about 2 W/(m•K), at least or up to about 3 W/(m•K), at least or up to about 4 W/(m•K), at least or up to about 5 W/(m•K), at least or up to about 6 W/(m•K), at least or up to about 7 W/(m•K), at least or up to about 8 W/(m•K), at least or up to about 9 W/(m•K), or at least or up to about 10.

The composite material of the present disclosure may exhibit a thermal conductivity that is between about 0.005 W/(m•K) and about 0.5 W/(m•K), between about 0.005 W/(m•K) and about 0.4 W/(m•K), between about 0.005 W/(m•K) and about 0.3 W/(m•K), between about 0.005 W/(m•K) and about 0.2 W/(m•K), between about 0.01 W/(m•K) and about 0.2 W/(m•K). or between about 0.01 W/(m•K) and about 0.16 W/(m•K).

The cellulosic material of the present disclosure may exhibit a thermal diffusivity of at least or up to about 0.01 square millimeter per second (mm²/s), at least or up to about, 0.05 mm²/s, at least or up to about 0.1 mm²/s, 0.15 mm²/s, at least or up to about 0.2 mm²/s, at least or up to about 0.25 mm²/s, at least or up to about 0.3 mm²/s, at least or up to about 0.35 mm²/s, at least or up to about 0.4 mm²/s, at least or up to about 0.45 mm²/s, at least or up to about 0.5 mm²/s, at least or up to about 0.6 mm²/s, at least or up to about 0.7 mm²/s, at least or up to about 0.8 mm²/s, at least or up to about 0.9 mm²/s, at least or up to about 1 mm²/s, at least or up to about 2 mm²/s, at least or up to about 3 mm²/s, at least or up to about 4 mm²/s, at least or up to about 5 mm²/s, at least or up to about 6 mm²/s, at least or up to about 7 mm²/s, at least or up to about 8 mm²/s, at least or up to about mm²/s, or at least or up to about 10 mm²/s.

The cellulosic material of the present disclosure may exhibit a thermal diffusivity that is between about 0.1 mm²/s and about 1 mm²/s, between about 0.1 mm²/s and about 0.5 mm²/s, between about 0.2 mm²/s and 0.5 mm²/s, or between about 0.2 mm²/s and 0.45 mm²/s.

The composite material of the present disclosure may exhibit a thermal diffusivity of at least or up to about 0.01 square millimeter per second (mm²/s), at least or up to about, 0.05 mm²/s, at least or up to about 0.1 mm²/s, 0.15 mm²/s, at least or up to about 0.2 mm²/s, at least or up to about 0.25 mm²/s, at least or up to about 0.3 mm²/s, at least or up to about 0.35 mm²/s, at least or up to about 0.4 mm²/s, at least or up to about 0.45 mm²/s, at least or up to about 0.5 mm²/s, at least or up to about 0.6 mm²/s, at least or up to about 0.7 mm²/s, at least or up to about 0.8 mm²/s, at least or up to about 0.9 mm²/s, at least or up to about 1 mm²/s, at least or up to about 2 mm²/s, at least or up to about 3 mm²/s, at least or up to about 4 mm²/s, at least or up to about 5 mm²/s, at least or up to about 6 mm²/s, at least or up to about 7 mm²/s, at least or up to about 8 mm²/s, at least or up to about mm²/s, or at least or up to about 10 mm²/s.

The composite material of the present disclosure may exhibit a thermal diffusivity that is between about 0.1 mm²/sand about 1 mm²/s, between about 0.1 mm²/s and about 0.5 mm²/s, between about 0.2 mm²/s and 0.5 mm²/s, or between about 0.2 mm²/s and 0.45 mm²/s.

In some cases, the composite material (e.g., the composite building material) as disclosed herein can be cured at a temperature of about 30° C. to about 1,500° C. In some cases, the composite material can be cured at a temperature of at least about 30° C. In some cases, the composite material can be cured at a temperature of at most about 1,500° C. In some cases, the composite material can be cured at a temperature of about 30° C. to about 40° C., about 30° C. to about 50° C., about 30° C. to about 100° C., about 30° C. to about 150° C., about 30° C. to about 200° C., about 30° C. to about 500° C., about 30° C. to about 1,000° C., about 30° C. to about 1,200° C., about 30° C. to about 1,500° C., about 40° C. to about 50° C., about 40° C. to about 100° C., about 40° C. to about 150° C., about 40° C. to about 200° C., about 40° C. to about 500° C., about 40° C. to about 1,000° C., about 40° C. to about 1,200° C., about 40° C. to about 1,500° C., about 50° C. to about 100° C., about 50° C. to about 150° C., about 50° C. to about 200° C., about 50° C. to about 500° C., about 50° C. to about 1,000° C., about 50° C. to about 1,200° C., about 50° C. to about 1,500° C., about 100° C. to about 150° C., about 100° C. to about 200° C., about 100° C. to about 500° C., about 100° C. to about 1,000° C., about 100° C. to about 1,200° C., about 100° C. to about 1,500° C., about 150° C. to about 200° C., about 150° C. to about 500° C., about 150° C. to about 1,000° C., about 150° C. to about 1,200° C., about 150° C. to about 1,500° C., about 200° C. to about 500° C., about 200° C. to about 1,000° C., about 200° C. to about 1,200° C., about 200° C. to about 1,500° C., about 500° C. to about 1,000° C., about 500° C. to about 1,200° C., about 500° C. to about 1,500° C., about 1,000° C. to about 1,200° C., about 1,000° C. to about 1,500° C., or about 1,200° C. to about 1,500° C. In some cases, the composite material can be cured at a temperature of about 30° C., about 40° C., about 50° C., about 100° C., about 150° C., about 200° C., about 500° C., about 1,000° C., about 1,200° C., or about 1,500° C. In some examples, the composite material can be cured at a temperature between about 30° C. and about 40° C.

In some cases, the composite material of the present disclosure may comprise the cellulosic material, a first binder material, and a second binder material. For example, the first binder material may comprise lime, and the second binder material may comprise silica. Once added to or mixed with the cellulosic material, the first and second binder materials may react to form a binder matrix, such as C-S-H cementitious matrix. The first binder material may be added to the cellulosic material prior to, concurrent with, or subsequent to adding the second binder material to the cellulosic material. In some examples, the first and second binder materials may be combined or mixed (e.g., without reacting to form the binder matrix), and the mixture (e.g., powder mixture) may be added to the cellulosic material.

In some embodiments, the composite material of the present disclosure may comprise one or more phase change materials (PCMs). Non-limiting examples of PCMs can include eutectic liquids, salts, salt hydrates, metal/metal alloys, alcohols, n-alkanes, and fatty acids. In some cases, the PCMs can be stabilized (e.g., during their phase change phenomenon) via encapsulation (e.g., microencapsulation or nanoencapsulation). Stabilization of the PCMs can include shape stabilization (or maintenance thereof). Stabilization of the PCMs can include property (e.g., thermal property) stabilization (or maintenance thereof). In some examples, the one or more PCMs can be mixed with one or mor components of the composite material, such as the binder material and/or the cellulosic material. For example, a porous nature of the binder material or the cellulosic material may allow for the one or more PCMs to be added to the composite (e.g., into one or more pores of the binder material or the cellulosic material), whether such PCMs are encapsulated or not. The porous structure within the binder material or the cellulosic material may stabilize (e.g., shape-stabilize) the one or more PCM materials, e.g., during phase change cycles in use of the composite material (e.g., as a building panel). The one or more PCMs can at least partially (e.g., partially, or entirely) fill one or more pores (e.g., some pores, or all pores) of the binder material or the cellulosic material. In some cases, the addition of the PCMs as disclosed herein may mitigate at least a portion of any loss of mechanical strength of the composite material. In some cases, addition of the PCM materials into the composite material may enhance specific heat capacity of the composite material (e.g., composite building material or composite building panel).

The cellulosic material may be or derived from a natural fiber. Examples of the natural fiber include a bast, leaf, seed, fruit, grass, wood, and any combination thereof. Examples of a source of the natural fiber include flax, hemp, kenaf, jute, ramie, isora, nettle, ananas, sisal, abaca, curua, cabuya, palm, opuntia, jipijapa, yucca, cotton, coir, kapok, soya, poplar, calotropis, luffa, bamboo, totora, hardwood, softwood, and any combination thereof.

In some embodiments, the cellulosic material as disclosed herein can be a wasted portion of a fibrous material, such as any natural fiber as disclosed herein. In some cases, a wasted portion of a fibrous material may be a leftover portion from utilizing the fibrous material to, for example, manufacture a different product (e.g., clothing, furniture, food, etc.) or to extract one or more components from the fibrous material (e.g., small molecules, such as oil or cannabinoid compounds from hemp). In some examples, the wasted potion of a fibrous material can be a spent fungus substrate, such as a spent mushroom substrate. The term “spent mushroom substrate” or “spent mushroom compost” as used interchangeably herein generally refers to a substrate used for cultivation of mushroom. A spent mushroom substrate can be a composted organic material remaining after a crop of mushrooms is harvested. Non-limiting examples of one or more components of a spent mushroom substrate can include, but are not limited to, softwood, coffee grounds, other ingredients are wheat straw bedding containing horse manure, hay, corn cobs, saw dust, cottonseed hulls, poultry manure, brewer’s grain, cottonseed meal, cocoa bean hulls, and gypsum.

In some embodiments, the cellulosic material as disclosed herein (e.g., a spent mushroom substrate or other cellulosic materials) can be at least partially delignified by fungal or enzymatic means, e.g., by using a fungus (e.g., a mushroom as disclosed herein) or an enzyme. A mushroom can be from a genus comprising Agaricus, Auricularia, Cordyceps, Coriolus, Ganoderma, Grifola, Hericuim, Lentinus, Pleurotus, Polyporus, Poria, Trametes, or Tremella. Non-limiting examples of a mushroom can include Agaricus augustus, Agaricus bisporus (e.g., white button mushroom), Agaricus blazei, Agaricus subrufescens, Cordyceps sinensis, Coriolus versicolor, Gandoderma lucidum, Ganoderma curtisii, Gandodermajaponicum, Ganoderma lingzhi (e.g., reishi mushroom), Ganoderma oregonense, Ganoderma sinense, Ganoderma tsugae, Grifola frondosa, Grifola umbellata, Lentinula edodes (e.g., shiitake mushroom), Polyporus frondosus, Polyporus umbellatus, Hericuim erimaceum, Lentinus edodes, Pleurotus ostreaus (e.g., oyster mushroom), Tremella fuciformis, and Trametes versicolor. Non-limiting examples of an enzyme for such at least partial delignification of a cellulosic material (e.g., breakdown of lignin and/or hemicellulose thereof) can include lignocellulosic enzymes such as laccase, xylanase, lignin peroxidase, cellulase and hemicellulose.

The removal of lignin and hemicellulose can be conducted through physical or chemical means. Alternatively or in addition to, pyrolysis may be performed to generate porous powders and/or aggregates in organic feedstocks.

Physical removal can include, but is not limited to, steam explosion, die extrusion, and mechanical/alkaline fractionation. The mechanical removal may be in the presence or absence of solvents.

The chemical selective depolymerization of lignocellulosic biomass, while maintaining cellulose crystal structure, can be achieved using the following groups/techniques of solvents: Kraft process, ionic liquids, sodium hydroxide, sodium sulfide, sulfates, chlorite, hypochlorite, with or without an acid catalyst, oxidizers, reducers, nucleophiles, electrophiles, organics, inorganics, halogens, noble gasses, metals, transition metals, acids, bases, neutrals, radicals, and in polar solvents or nonpolar solvents. Crystal structure refers to the ordered arrangement of atoms or molecules in solid materials, and can also be described as the lattice structure. In the present disclosure, cellulose molecules are unaltered which means the unit cells remain in the material with its original orientation and structure. In prior art, chemical treatments are aimed at depolymerizing cellulose, hemicellulose, and lignin. The present disclosure takes an alternative approach by selectively depolymerizing hemicellulose and lignin without changing the orientation of the cellulose which acts as the structural backbone for the plant.

An ionic liquid can be solid or liquid at room temperature, and is based on weak ionic attractions between a cation and an anion. The cation is frequently bulky in size which distributes the positive charge across a larger electron cloud. The anion is generally smaller in the number of molecules which makes the negative concentrated over fewer electronegative atoms. The disproportion in size between the anion and cation leads to weak positive and negative electrochemical attraction. This is where the term ionic liquid is derived because strong ionic attractions usually produce solid materials, but the distribution of charges allows for liquids to be present at room temperature or at slightly elevated temperatures between 20° C. (°C) and 50° C. In some cases, liquid phase solvent may be essential for saturation of the lignocellulosic material as solids would not provide the appropriate mechanisms to effectively and selectively depolymerize the lignin and hemicellulose away from the cellulose which are bound to cellulose through strong hydrogen bonds. A hydrogen bond is a strong chemical attraction between the lone pair of electrons present on oxygen, nitrogen, or fluorine and a hydrogen atom. The ionic liquids comprise organic cations created by derivatizing one or more compounds to include substituents, such as alkyl, alkenyl, alkynyl, alkoxy, alkenoxy, alkynoxy, a variety of aromatics, such as (substituted or unsubstituted) phenyl, (substituted or unsubstituted) benzyl, (substituted or unsubstituted) phenoxy, and (substituted or unsubstituted) benzoxy, and a variety of heterocyclic aromatics having one, two, or three heteroatoms in the ring portion thereof, the heterocyclics being substituted or unsubstituted. The derivatized compounds include, but are not limited to, imidazoles, pyrazoles, thiazoles, isothiazoles, azathiozoles, oxothiazoles, oxazines, oxazolines, oxazaboroles, dithiozoles, triazoles, delenozoles, oxaphospholes, pyrroles, boroles, furans, thiophenes, phospholes, pentazoles, indoles, indolines, oxazoles, isoxazoles, isotetrazoles, tetrazoles, benzofurans, dibenzofurans, benzothiophenes, dibenzothiophenes, thiadiazoles, pyridines, pyrimidines, pyrazines, pyridazines, piperazines, piperidines, morpholones, pyrans, annolines, phthalazines, quinazolines, guanidiniums, quinxalines, choline-based analogues, and combinations thereof. The basic cation structure can be singly or multiply substituted or unsubstituted.

The anionic portion of the ionic liquid can comprise an inorganic moiety, an organic moiety, or combinations thereof. In preferred embodiments, the anionic portion comprises one or more moieties selected from halogens, phosphates, alkylphosphates, alkenylphosphates, bis(trifluoromethylsulfonyl)imide (NTf2), BF4 , PF6 , AsF6 , NO3 , N(CN)2 , N(SO3CF3)2 , amino acids, substituted or unsubstituted carboranes, perchlorates, pseudohalogens such as thiocyanate and cyanate, metal chloride -based Lewis acids (e.g., zinc chlorides and aluminum chlorides), or C1-6 carboxylates. Pseudohalides are monovalent and have properties similar to those of halides. Non-limiting examples of pseudohalides may include cyanides, thiocyanates, cyanates, fulminates, and azides. Exemplary carboxylates that contain 1-6 carbon atoms are formate, acetate, propionate, butyrate, hexanoate, maleate, fumarate, oxalate, lactate, pyruvate and the like. A variety of further anionic moieties are also envisioned and encompassed by the present disclosure. For example, ionic liquids based on alkyl imidazolium or choline chloride anol-aluminum chloride, zinc chloride, indium chloride, and the like may be used. In some cases, various further Lewis acid inorganic salt mixtures may be used.

Non=limiting examples of cellulose precursor can include, but are not limited to, grasswoods, softwoods, hardwoods, plants, and recycled cellulose products such as newspaper and denim.

In some cases, the resulting thermal resistivity or R-value (insulating performance metric), is between the range of about 2 to about 3 in SI units of square meter Kelvin per watts (m²·K/W) or square meter Celsius per watts (m²·°C/W). In some cases, the resulting R-value is between about 3 to about 4 (m²·K/W or m²·°C/W). In some cases, the resulting R-value is between about 4 to about 6 (m²·K/W or m²·°C/W). In some cases, the R-value may be at least about 2 m²·K/W, 3 m²·K/W, 4 m²·K/W, 5 m²·K/W, 6 m²·K/W, or more. In some cases, the R-value may be at most about 6 m²·K/W, 5 m²·K/W, 4 m²·K/W, 3 m²·K/W, 2 m²·K/W, or less. In some cases, the R-value may be at least about 2 m²·°C/W, 3 m²·°C/W, 4 m²·°C/W, 5 m²·°C/W, 6 m²·°C/W, or more. In some cases, the R-value may be at most about 6 m²·°C/W, 5 m²·°C/W, 4 m²·°C/W, 3 m²·°C/W, 2 m²·°C/W, or less.

In some cases, the removal of lignin and hemicellulose occurs on the order of about 0.01 percent (%) to about 10% removal relative to initial chemical compositions. In some cases, the removal of lignin and hemicellulose occurs on the order of about 10% to about 50% removal relative to initial chemical composition. In some cases, the removal of lignin and hemicellulose occurs on the order of about 50% to about 99% removal relative to initial chemical compositions. In some cases, it is possible to achieve 100% removal. In some cases, the removal of lignin and hemicellulose may occur on the order of at least about 0.01%, 0.05%, 0.1%, 0.5%, 1%, 5%, 10%, 20%, 30%, 40%, 50%, 60%, 70%, 80%, 90%, 99%, or more. In some cases, the removal of lignin and hemicellulose may occur on the order of at most about 100%, 90%, 80%, 70%, 60%, 50%, 40%, 30%, 20%, 10%, 5%, 1%, 0.5%, 0.1%, 0.05%, 0.01%, or less.

In some cases, the disclosed methods of removal of at least a portion of the lignin may result in the cellulosic materials losing all crystal structure associated with the cellulose fibrils which would result in a loss in surface area. Better case, cellulose crystallinity remains only slightly reduced in the range between about 0.01% to about 9%, resulting in a slight increase in surface area and porosity. Best case cellulose crystal structure doesn’t change at all, resulting in the highest possible increase in surface area and porosity. In some cases, the removal of lignin would result in a loss of the cellulose crystallinity in the range between about 0% to about 100%. In some cases, the removal of lignin would result in a loss of the cellulose crystallinity of at least about 0.01%, 0.05%, 0.1%, 0.5%, 1%, 5%, 9%, 10%, 50%, 90%, 99%, or more. In some cases, the removal of lignin would result in a loss of the cellulose crystallinity of at most about 100%, 99%, 90%, 50%, 10%, 9%, 5%, 1%, 0.5%, 0.1%, 0.05%, 0.01%, or less.

The solution conditions for the chemical treatment can be conducted from about 0° C. to about 200° C. In some cases, the solution conditions may be at least about 0° C., 5° C., 10° C., 50° C., 100° C., 150° C., 200° C., or more. In some cases, the solution condition may be at most about 200° C., 150° C., 100° C., 50° C., 10° C., 5° C., 1° C., or less. Similarly, the atmospheric conditions can be done under vacuum, standard atmospheric pressure, elevated pressures, or under inert gas conditions.

### Industrial Insulating Products (e.g., Using Hemp)

The industrial hemp can be mechanically processed after harvest. The mechanical processing will include the physical separation of the bast fiber and the hurd. The bast fiber and hurd are cut into smaller pieces with varying ranges of fiber length to create small clumps of individual fibers. In some cases, the size of the bast fiber and/or the hurd can have an average size of about 63.5 millimeters (mm). In some cases, the size of the bast fiber and/or the hurd can have an average size of at least about 63.5 mm. In some cases, the size of the bast fiber and/or the hurd can have an average size of at most about 63.5 mm.

The creation of the insulating material will comprise a volumetric ratio of bast fiber to hurd. The ratio of bast fiber to hurd can be within the range of about 40% by fiber by volume up to about 100% bast fiber by volume, with the remaining material consisting of hemp hurd. In some cases, the ratio of bast fiber to hurd by volume may be at least about 30%, 40%, 50%, 60%, 70%, 80%, 90%, 99%, or more. In some cases, the ratio of bast fiber to hurd by volume may be at most about 100%, 90%, 80%, 70%, 60%, 50%, 40%, 30%, or less.

The classical methods described above for the delignification or pulping of lignocellulosic materials, although each possesses certain practical advantages, can all be characterized as being hampered by significant disadvantages. Thus, there exists a need for delignification or pulping processes which have a lower capital intensity, lower operation costs, either in terms of product yield of the process or in terms of the chemical costs of the process; which are environmentally benign; which produce delignified materials with superior properties; and which are applicable to a wide variety of lignocellulosic feed materials. Such processes should preferably be designed for application in existing pulp mills using existing equipment with a minimum of modifications.

It is known in the prior art that cellulose pulp can be manufactured from wood chips or other fibrous material by the action of oxygen in an alkaline solution. However, the commercial use of oxygen in support of delignification today is limited to final delignification of kraft or sulfite pulps.

The oxygen pulping methods considered in the prior art for the preparation of full chemical pulps can be divided in two classes: two-stage soda oxygen and single stage soda oxygen pulping. Both single stage and two stage processes have been extensively tested in laboratory scale. In the two stage process the wood chips are cooked first in an alkaline buffer solution to a high kappa number after which they are mechanically disintegrated into a fibrous pulp. This fibrous pulp with a high lignin content is further delignified with oxygen in an alkaline solution to give a low kappa pulp in substantially higher yields than obtained in a kraft pulping process.

The single stage process is based on penetration of oxygen through an alkaline buffer solution into the wood chips. The alkaline solution is partly used to swell the chips and to provide a transport medium for the oxygen into the interior of the chip. However, the main purpose of the alkaline buffer solution is to neutralize the various acidic species formed during delignification. The pH should not be permitted to drop substantially below a value of about 6-7. The solubility of the oxygen in the cooking liquor is low and to increase solubility a high partial pressure of oxygen has to be applied.

Several attempts have been made to accomplish oxygen pulping using mechanical and/or chemical processes, but to the inventor’s knowledge none has simultaneously addressed all the problem areas described above and the prior art disclosures do not include or suggest any practical and efficient method for the recovery of pulping chemicals.

In some embodiments, methods of the present disclosure does not require prehydrolysis steps that are implemented in prior art to dissolve hemicellulose which could make accessing lignin easier. These techniques include, alkali soaking at temperatures of 170° C. and above, transition metal catalysts, acid washes, and steam explosion. In some cases, the methods may require a single hydrolysis step in which both the lignin and hemicellulose are removed by a single step chemical treatment. This is important because these additional steps are costly at scale, require environmentally hazardous chemicals, rely on significant thermal energy input, and require special equipment that may not degrade due to the presence of strong oxidizers at high temperatures.

In some embodiments, the methods disclosed herein can include mechanical pretreatments such as grinding, fluffing, wafering, milling, cutting, and fiberizing. The goal of this mechanical pretreatment is to further expose the hemicellulose and lignin that need to be selectively depolymerized. This is achieved due to the increase in surface area to volume ratio associated with reducing particle size which allows for more effective penetration of the proceeding chemical treatment. The average particle size should be between about 1 mm to about 63.5 mm. In some cases, the average particle size may be at least about 0.1 mm, 0.2 mm, 0.4 mm, 0.6 mm, 0.8 mm, 1 mm, 2 mm, 4 mm, 6 mm, 8 mm, 10 mm, 20 mm, 30 mm, 40 mm, 50 mm, 60 mm, 70 mm, or more. In some cases, the average particle size may be at most about 70 mm, 60 mm, 50 mm, 40 mm, 30 mm, 20 mm, 10 mm, 8 mm, 6 mm, 4 mm, 2 mm, 1 mm, 0.8 mm, 0.6 mm, 0.4 mm, 0.2 mm, 0.1 mm, or less.

The solution composed of fiber, hurd, and chemical solvents can be mechanically stirred but is not required. The temperature of the solution can be within the range between about 20° C. to about 130° C. In some cases, the temperature of the solution may be at least about 10° C., 20° C., 40° C., 60° C., 80° C., 100° C., 120° C., 130° C., or more. In some cases, the temperature of the solution may be at most about 130° C., 120° C., 100° C., 80° C., 60° C., 40° C., 20° C., 10° C., or less.

The solution is heated until steady state is reached for the entirety of this chemical process. The solution heating process time may range from about 10 minutes (min) to about 7 hours (h). The solution heating process may be at least about 1 min, 5 min, 10 min, 30 min, 1 h, 2 h, 3 h, 4 h, 5 h, 6 h, 7 h, or longer. The solution heating process may be at most about 7 h, 6 h, 5 h, 4 h, 3 h, 2 h, 1 h, 30 min, 10 min, 5 min, 1 min, or shorter.

The depolymerizing chemical solvents may be reintroduced (recharged) into the solution as frequently as every hour interval, or not recharged at all. In some cases, the depolymerizing chemical solvents may be reintroduced at a time interval of about 1 h. In some cases, the depolymerizing chemical solvents may be reintroduced at a time interval of more than 1 h. In some cases, the depolymerizing chemical solvents may be reintroduced at a time interval of less than 1 h.

At the completion of the chemical treatment, the solvent can be drained and regenerated for reuse up to 4 times with little to no loss in their effectiveness. In some cases, the solvent may be drained and regenerated for reuse up to more than 4 times. In some cases, the solvent may be drained and regenerated for reuse up to less than 4 times. Many valuable components from the cellulosic anatomy will be found within the solvent stream including but not limited to: cellulose sugars, xylose sugars, lignin, lignin derivatives, pectin, and alcohol precursor materials. The selective depolymerization of cellulose and maintaining original crystal structure allows for a less chemical intensive process to the material. This allows for easier isolation of the many valuable components within the post chemical treatment solvent by allowing fewer oxidation reactions to occur that would otherwise destroy the molecular nature of these valuable components.

The remaining pulp is then dried with either fans and or conventional ovens, at temperature range between 110-135° F. (°F),. The heat range is specific to the material so that the cellulose crystal structure created is maintained and not disrupted due to excess heat. In some cases, the remaining pulp may be dried at a temperature of at least about 100° F., 110° F., 120° F., 130° F., 140° F., or more. In some cases, the remaining pulp may be dried at a temperature of at most about 140° F., 130° F., 120° F., 110° F., 100° F., or less.

In some examples, the cellulosic material as disclosed herein can be at least partially delignified to exhibit (i) increased porosity and (ii) at least a portion of crystal structure of the cellulosic material is maintained, as compared to a corresponding control cellulosic material without such at least partial delignification. Such at least partial delignification can increase specific heat capacity of the cellulosic material. Alternatively or in addition to, the increased specific heat capacity of the cellulosic material can be due to a controlled change in the porosity within the cellulosic material (e.g., increase or decrease of the porosity). Alternatively or in addition to, the increased specific heat capacity of the cellulosic material can be due to drying the cellulosic material, e.g., with low to zero heat input. The increased specific heat capacity can be at least or up to about 1%, at least or up to about 2%, at least or up to about 5%, at least or up to about 10%, at least or up to about 15%, at least or up to about 20%, at least or up to about 30%, at least or up to about 40%, at least or up to about 50%, at least or up to about 60%, at least or up to about 70%, at least or up to about 80%, at least or up to about 90%, at least or up to about 100%, at least or up to about 150%, at least or up to about 200%, at least or up to about 300%, at least or up to about 400%, at least or up to about 500%, at least or up to about 600%, at least or up to about 700%, at least or up to about 800%, at least or up to about 900%, or at least or up to about 1000%, as compared to a corresponding control, e.g., (i) a corresponding control cellulosic material without the at least partial delignification, (ii) a corresponding control cellulosic material without the controlled increase in porosity, (iii) a corresponding control cellulosic material without the controlled decrease in porosity, (iv) a corresponding control cellulosic material without the drying stem (e.g., with low to zero external heat input), etc.

The drying process can include the use of ethanol to displace the water found within the pores and cavities of the material created. Ethanol will displace the water and also has a lower boiling point temperature, which will lead to quicker drying.

The pulp is then left with air-filled voids or pressurized in an inert gas environment due to higher thermal resistance of CO2, H2 gases and similar gases compared to air.

The chemical solvent may also be regenerated or recycled. This is most often achieved by pH adjustments, and application of pressure or vacuum.

At the completion of the wet chemical process, fire retardant materials are then added. Flame retardants can include, but are not limited to, borate derivatives, magnesium oxides, oxides, organics, and acrylates. The fire retardants can be added to the material with fraction of 6-30% by weight.

Alternatively or in addition to, the fire retardants may be organohalogen compounds. Examples of the organohalogen compounds include: organochlorines (e.g., chlorendic acid derivatives and chlorinated paraffins); organobromines (e.g., decabromodiphenyl ether (decaBDE); polymeric brominated compounds (e.g., brominated polystyrenes, brominated carbonate oligomers (BCOs), brominated epoxy oligomers (BEOs), tetrabromophthalic anyhydride, tetrabromobisphenol A (TBBPA), and hexabromocyclododecane (HBCD)); and mixtures thereof.

Alternatively or in addition to, the fire retardants may be organophosphorous compounds. Examples of the organophosphorous compounds include: organophosphates (e.g., triphenyl phosphate (TPP), resorcinol bis(diphenylphosphate) (RDP), bisphenol A diphenyl phosphate (BADP), and tricresyl phosphate (TCP)); phosphonates (e.g., dimethyl methylphosphonate (DMMP)); phosphinates (e.g., aluminium diethyl phosphinate); and mixtures thereof.

Alternatively or in addition to, the fire retardants may be silica based aerogels. Silica aerogels are fire resistant and provide inherent insulating properties in addition to the porous cellulose - fire retardant composite created herein.

In some cases, the fire retardants may contain both the phosphorus and halogen (e.g., tris(2,3-dibromopropyl) phosphate (brominated tris), tris(1,3-dichloro-2- propyl)phosphate (chlorinated tris or TDCPP), and tetrakis(2-chloroethyl)dichloroisopentyldiphosphate)).

Additionally, crosslinking agents can be mixed with the fire retardants to induce gelling. This creates a fire retardant with increased viscosity for more effective chemical bonding onto the cellulose pores for increased insulation performance. Examples of a crosslinking agent to fire retardants includes polyvinyl alcohol in addition to water. Current methods of adding fire retardant additives to cellulose include a dry process and primarily induce physical bonding.

The created fire retardant has a viscosity in between about 10 centipoise (cP) to about 10,000 cP to induce further chemical bonding to cellulose. In some cases, the viscosity of the created fire retardant may be at least about 1 cP, 5 cP, 10 cP, 50 cP, 100 cP, 500 cP, 1,000 cP, 5,000 cP, 10,000 cP, or more. In some cases, the viscosity of the created fire retardant may be at most about 10,000 cP, 5,000 cP, 1,000 cP, 500 cP, 100 cP, 50 cP, 10 cP, 5 cP, 1 cP, or less.

The material will then be fiberized and will have the fire retardants added either prior, during or after fiberization. Fiberization is the typical blown cellulose insulation manufacturing process that is used to achieve the material’s overall macroscopic density by chopping of the input fibers and creating a material of low density with known average fiber size, which increases insulation properties. The material created herein is manufactured similarly to these blown cellulose insulation materials, but is unique and innovative due to the porosity not just existing at the macro scales. The material created has cellulosic material components depolymerized which creates micro and nanopores which increase thermal and acoustic insulating performances. The material is then subjected to fiberization which results into small clumps individual fibers, with fiber lengths having an average of about 63.5 mm. The average fiber length may be at least about 63.5 mm. The average fiber length may be at most about 63.5 mm. The material created has a density ranging between about 2.5 to about 3.7 lb/ft³. The density of the material created may be at least about 1 lb/ft³, 2 lb/ft³, 2.5 lb/ft³, 3 lb/ft³, 3.5 lb/ft³, 4 lb/ft³, or more. The density of the material created may be at most about 4 lb/ft³, 3.5 lb/ft³, 3 lb/ft³, 2.5 lb/ft³, 2 lb/ft³, 1 lb/ft³, or less. The material can be dry or slightly wet during the addition of the fire retardants. The resulting material consists of small clumps of insulating fibers which have open and closed cells and are fire resistant. The material is also flexible and can take the shape of any cavity it is installed into.

The fire retardants added can consist of borate based fire retardants including: aluminum ammonium sulfate; magnesium silicate; aluminum hydroxide; and mixtures of calcium magnesium carbonate and hydrated magnesium carbonate hydroxide, or wood ash based fire retardant including: potash alum (potassium aluminum sulfate); calcium carbonate; sodium carbonate; talc; or clay.

The addition of the fire retardant allows for the creation of closed cell, or semi-closed cell pores within the material due to the chemical treatment’s creation of porosity and the selective blocking of macro and nanopores within our material. In the worst-case scenario, the fire retardants create a semi-closed cell material for a slight increase in R Value, where about 10% to about 70% of the open cells are converted to closed cell. In the best case, the fire retardants allow for the creation of closed cells for highest R Value increase, where about 70% to 100% of open cells are converted to closed cell. In some cases, at least about 10%, 20%, 30%, 40%, 50%, 60%, 70%, 80%, 90%, 99%, or more of the open cells may be converted to the closed cell. In some cases, at most about 100%, 90%, 80%, 70%, 60%, 50%, 40%, 30%, 20%, 10%, or less may be converted to the closed cell.

The fire retardant can be applied within a range of about 5% to about 70% retardant by weight. In some cases, the fire retardant may be at least about 5%, 10%, 20%, 30%, 40%, 50%, 60%, 70%, or more by weight. In some cases, the fire retardant may be at most about 70%, 60%, 50%, 40%, 30%, 20%, 10%, 5%, or less by weight.

The viscous, wet fire retardants are added onto the chemically treated porous fibers through a pneumatic mechanical process at a specific flow rate. Pneumatic mechanical processes have mass transport of specific materials through pressurized air flows induced by high strength fans. The fibers will also be fed into the mechanical pneumatic system at a specified flow rate. The fire retardants can have mass flow rates ranging from about 0.1 grams/seconds (g/s) to about 5000 g/s. The treated porous fibers can have mass flow rates ranging from about 0.1 to about 5000 g/s.

The combination of cellulosic material and fire retardant is then dried. The drying mechanism can be through convection, conduction, or radiation and can take place across a range of temperatures from ambient (e.g., about 77° F.) to about 150° F. Mechanical drying through use of fans may be implemented to induce evaporative effects. Sufficient drying will be achieved when the weight of the sample is substantially constant for about 10 min. The weight of the product will continue to drop as more and more water vaporizes at elevated temperatures. It is understood that the material will reabsorb ambient water vapor up to approximately 6% by weight after the drying process, but to remove any residual solvents monitoring the weight will be of great value. Drying temperature is specific to the cellulose material used so that maintaining crystal structure is not compromised.

In some cases, the cellulosic fibers may be wetted with water prior to the addition of fire retardants. Such wetting may increase fiber weights by a range between about 5% to about 15% by weight. Wetting can be performed through spraying, misting, and/or steaming of water onto fiber surfaces. Subsequently, dry fire retardant powders can be added to the wet fibers through mechanical and pneumatic processes with uniform distribution to induce future liquefying of the solid powders into viscous forms, thereby to promote fire retardant binding onto the fiber pores and surfaces.

In some cases, the fire retardants can be liquefied and then added as a viscous material onto the fiber pores and surfaces through heating methods.

In some cases, a steam vent or chamber may be introduced after the fibers have been converted into a non-woven web of insulation with predetermined composition. The steam may be used to further wet the fibers to induce liquefying of remaining dry solid powders. The remaining fire retardant powders that may be dry (e.g., in a solid form) in the non-woven insulation web may include about 1% to about 85% of the total initial fire retardant weight initially introduced into the composite non-woven web. The liquefaction process can improve the capping ability of these fire retardants due to increased chemical and physical bonding.

In some cases, the steam can make contact with the composite non-woven web through any surface and direction of flow rate.

In some cases, the steam can be introduced through many pipes, ranging in sizes of about 0.75 inches to about 12 inches.

In some cases, the steam introduced can be wet (unsaturated steam), dry (saturated steam), or superheated. In some cases, the steam may have a flow rate between about 9 lb/hour to about 81,000 lb/hour per square foot of composite non-woven insulation manufactured.

some cases, the manufactured composite non-woven insulation that includes the fire retardant can be subjected to heat. Such manufactured composite non-woven insulation can be introduced to a heater (e.g., in an oven or a thermobonding oven, etc.) to further induce hardening or gelling of the fire retardants onto the fiber pores and surfaces. Such heating may promote increased bonding (e.g., a physical bonding, adhesion, etc.) between the fire retardant and the fibers (cellulosic materials). As the fibers continue to remain in the heater, drying may occur. Such drying may induce capping of the fiber pores. The initial natural fiber water content may range from about 3% to about 11% by weight in the web, prior to heating. In some cases, the initial water content in the natural fiber prior to heating may be at least about 1%, 2%, 3%, 4%, 5%, 6%, 7%, 8%, 9%, 10%, 11%, 12%, 15%, 20% or more by weight. In some cases, the initial water content in the natural fiber prior to heating may be at most about 20%, 15%, 12%, 11%, 10%, 9%, 8%, 7%, 6%, 5%, 4%, 3%, 2%, 1%, or less by weight. An additional input of water moisture content for the non-woven composite may be introduced, thereby increasing the water moisture content by about 5% to about 20% by weight, prior to heating. In some cases, the water moisture content may be increased by at least about 1%, 5%, 10%, 15%, 20%, 25%, 30%, or more by weight. In some cases, the water moisture content may be increased by at most about 30%, 25%, 20%, 15%, 10%, 5%, 1%, or less by weight. After heating, remaining water content may range from about 3% to about 11%. In some cases, the remaining water content may be at least about 1%, 2%, 3%, 4%, 5%, 6%, 7%, 8%, 9%, 10%, 11%, 12%, 15%, 20% or more by weight. In some cases, the remaining water content may be at most about 20%, 15%, 12%, 11%, 10%, 9%, 8%, 7%, 6%, 5%, 4%, 3%, 2%, 1%, or less by weight. In some cases, the heating process may range between about 10 min to about 90 min. In some cases, the heating process may be at least about 1 min, 5 min, 10 min, 50 min, 90 min, 100 min, 200 min, or more. In some cases, the heating process may be at most about 200 min, 100 min, 90 min, 50 min, 10 min, 5 min, 1 min, or less. In some cases, the heating process may be one continuous heating process. In some cases, the heating process may occur in intervals. In some cases, the heating process may depend on water moisture content. In some cases, the heating temperature may range between about 100° C. to about 500° C. In some cases, the heating temperature may range between about 175° C. to about 350° C. In some cases, the heating temperature may be at least about 100° C., 125° C., 150° C., 175° C., 200° C., 250° C., 300° C., 350° C., 400° C., or higher. In some cases, the heating temperature may be at most about 400° C., 350° C., 300° C., 250° C., 200° C., 175° C., 150° C., 125° C., 100° C., or lower.

In some cases, the final material may be subjected to a water, oil, or emulsion based dye. The results should induce color change of the material to allow for recognizable branding. The dye is applied to the material before or after drying. The color can be added onto the material during post chemical washing through a water-soluble dye. The color can also be added onto the material post fiberization with a spray applied dye. Dying is not a requirement for the product but is attractive to the consumer eye and resembles healthiness and cleanliness.

### Thermal Resistivity

The selective removal, or depolymerization, of lignin and hemicellulose biopolymers will induce anatomical changes within the anatomy of the cellulose fibril matrix.

Cellulose with high crystal structure is more thermally stable compared to lignin and hemicellulose. This is due to the absence of highly amorphous regions which can be found in lignin and hemicellulose. Phonon transportation through the stable cellulose is thus inhibited due to its ability to maintain structural integrity during conduction, convection and radiation forms of heat transfer.

The chemical treatment mechanisms are acid hydrolysis, coordinating anion attack of bonds, or oxidation within the lignin structures. Specifically, the bonds targeted for cleavage are the aryl ethyl bonds that connect the phenolic groups of the lignin structure. Under hydrolysis conditions, the hemicellulose components are solubilized and the lignin is partially hydrolyzed by cleavage of α-aryl and phenolic β-O-4 ether linkages.

Mechanism for Acid Catalyzed Hydrolysis of b-O-4 Linkages in Ionic Liquids with coordinating anion includes: (1) Protonation of the benzylic alcohol; (2) Elimination of H2O through E2 mechanism to form alpha-beta unsaturated enol ether; (3) Hydration of C-C double bond followed by proton transfer to form hemiacetal; and (4) Protonation of phenolic oxygen followed by elimination mechanism to form phenolic derivative and Hibbert’s ketone.

Mechanism for Acid Catalyzed Hydrolysis of b-O-4 Linkages in Ionic Liquids without coordinating anion includes: (1) Protonation of the benzylic alcohol; (2) Elimination of H2O and formaldehyde to form enol ether; (3) Hydration of C-C double bond and proton transfer to form hemiacetal; and (4) Protonation of phenolic oxygen followed by elimination to form phenolic derivative and vinyl alcohol.

The hemicellulose structures are predisposed to being dissolved by polar based solvents, specifically water. The predisposition is especially true in acidic conditions such as the one described by the present disclosure. This is due to the low degree of crystallinity, and lower molecular weight relative to cellulose and lignin.

Removing the secondary support structures of cellulose may induce cellulose agglomeration to form macro and nanoscale voids within the cellulose matrix. This is especially true within areas of the plant material that specifically have high lignin concentration such as the secondary cell wall. The agglomeration of cellulose fibrils along the secondary cell wall results in long hollow tubes that run the length of the fibril. The result is reduced density of the material due to the removal of the described components, and similarly an increase in the presence of insulating air.

The application of the fire retardants, wet or dry, will close off the newly created voids making them closed cell air pockets. The fire retardants are added as an additional layer to the surface of the insulation material created. It is applied to the material in a weight percentage between 6-30%. It is understood that closed cell insulation is a method for establishing insulating air pockets, and is the underlying principle of insulation mechanisms for other insulating materials such as aerogels and foams.

To maintain maximum surface area of closed cell voids, the cellulose crystal structure must be maintained. This can be determined by characterization techniques such as X-Ray Diffraction (XRD), Differential Scanning Calorimetry (DSC), and Thermogravimetric Analysis (TGA). XRD exposes the material to X-ray radiation at a variety of angles that interact with the atomic lattice. The interactions and returning X-ray energy can be recorded and analyzed to determine percent crystallinity. This is achieved by observing the characteristic intensities of the crystalline region of cellulose, which is known to occur at 22.6°. The amorphous or non-crystalline region of cellulose occurs at 18.06°, and this intensity is mathematically related to the observed intensity of the crystalline cellulose region, which gives an approximation to the overall percent crystallinity of the remaining cellulose. The mathematical equation is listed as follows (Equation 1):

$$\% \text{Crystalline=} \frac{{I}_{22}}{{I}_{23} + {I}_{18}} \times 100$$

The method of inducing closed cell voids within cellulosic materials also increases the acoustic insulating performance by the same principles described. This is an important feature that current thermal insulators fail to provide.

### Extraction and Isolation of Byproducts

The residual liquid (named liquor) that remains from the chemical treatment may include solvent, dissolved or undissolved solids, chemical compounds, isolated components, thermal energy, and any derivative of the lignocellulosic anatomy.

From the liquor, a number of extraction techniques may be applied to isolate and collect chemical compounds including but not limited to: cyclic compounds (sugars and carbohydrates), noncyclic compounds, Carboxylic Acids, Acid Anhydrides, Esters, Acyl Halides, Amides, Nitriles, Aldehydes, Ketones, Alcohols, Thiols, Amines, Ethers, Sulfides, Alkenes, Alkynes, Alkyl Halides, Nitro groups, Alkanes, non-organics, ionic liquids, protons, and any common derivative of cellulose, hemicellulose, lignin, or pectin.

Extraction may be liquid-liquid extraction or solid phase extraction. Extraction chemicals can be nucleophilic, electrophilic, acidic, basic, neutral, metallic, inorganic, polar, nonpolar, organic, and in solid, liquid, or gas phases.

The extraction may be conducted under vacuum, ambient atmospheric pressure, or with increased pressure.

The extraction may be conducted within a temperature range of -50° to 110° C.

Further techniques may be implemented to isolate or purify the desired byproduct.

### Nonwoven Cellulosic Composite

Nonwoven cellulosic webs are commonly referred to as batt forms of insulation, and are the primary type of insulation used in residential buildings.

The creation of this batt insulation includes all of the previously described processes, but has additional manufacturing steps and components. The primary difference between cellulose blow-in and a nonwoven web is the addition of a binding agent that allows the batt insulation to maintain its shape and loft.

In some cases, binders as disclosed herein can comprise low temperature melting materials (e.g., thermoplastics, such as poly(lactic) acid (PLA) fiber, polysulfone, and polyester fiber). Bleaching of the fibers can enhance chemical and physical bonding of the binder and fire retardant due to increased surface area and surface roughness. In some cases, the binders can comprise a family of PLA-Lignin copolymers including the varying number average and weight average molecular weights, degree of acetylation, end groups, functional groups, and growth methods. The use of PLA-Lignin copolymers can be an important component of the disclosed methods because the basis of the copolymer can be isolated from the waste stream of the bleaching process.

### Waterproof Material

In some embodiments, a composite material as disclosed herein can comprise a cellulosic material (e.g., that is at least partially delignified) as disclosed herein and (i) a binder material as disclosed herein (e.g., a binder material comprising lime) and/or (ii) a waterproofing material (i.e., a waterproofing agent). The composite material can comprise only one of the binder material and the waterproofing material. Alternatively, the composite material can comprise both the binder material and the waterproofing material. The waterproofing material can be added to the cellulosic material prior to, simultaneously with, or subsequent to addition of the binder material to the cellulosic material. In some cases, the waterproofing material can be a fire retardant or exhibit fire resistance.

In some cases, the waterproofing material can be mixed with the binder agent, and the mixture can be added to the cellulosic material. In some cases, the waterproofing material can be added to (or mixed with, blended with under shear, etc.) the binder material (e.g., a binder slurry) prior to adding the resulting mixture to the cellulosic material. For example, the waterproofing material and the binder material can be blended together under shear in processes similar in preparing cementitious and pozzolanic slurry. In some cases, the waterproofing material can be applied (e.g., poured, painted on, sprayed on, dried, etc.) to the cellulosic material, which cellulosic material may or may not comprise the binder agent.

In some cases, the waterproofing material may be capable of crystallizing (e.g., in the presence of a liquid, such as water) to form a network or mesh (e.g., a hydrophobic network for mesh) within one or more pores of the cellulosic material.

The waterproofing material can comprise one or more fire retardants as disclosed herein. Alternatively or in addition to, the waterproofing material can comprise different components than the fire retardants of the present disclosure.

The waterproofing material can be a hydrophobic material.

(Non-limiting examples of the waterproofing material as disclosed herein can include inorganic waterproofing materials, organic waterproofing materials, halogen-containing waterproofing materials, and oxide-based waterproofing materials. Examples of inorganic waterproofing materials can include, but are not limited to, a composite material that comprises one or more members from sodium silicate solutions, deionized water, metal-based catalyst, sodium hydrate, a surfactant, siloxane, and/or a silicon emulsion. In an example, an inorganic waterproofing material can be a sodium silicate-based sealer (e.g., a sodium silicate-based concrete sealer). In an example, an inorganic waterproofing material can be a polymeric material. Examples of organic waterproofing materials can include, but are not limited to, stearates (e.g., calcium, sodium, butyl stearates, etc.), hydrophobic material (e.g., metallic or organic soap of a paraffinic acid; ester of a paraffinic acid, oleic acid, a wax emulsion, etc.), etc. Examples of halogen-containing waterproofing material can include, but are not limited to, a polymeric chain comprising one or more (e.g., a plurality of) halogen containing functional groups (e.g., acetal, alkyl, phenyl, ketal groups, etc.) with one or more (e.g., a plurality of) halogen atoms, such as chlorine or fluorine atoms. Examples of oxide-based waterproofing materials can include, but are not limited to, zinc oxides and graphene oxides. The oxide-based waterproofing materials can be deployed with surface modifying agents (e.g., silanes) to attach the oxides to a surface (e.g., a surface of the cellulosic material).

### Panel

In some embodiments of any one of the subject composite materials (e.g., composite building materials), the composite material can be used to form (or manufacture) one or more panels for a building, such as residential and/or commercial buildings. In some cases, a panel as disclosed herein can be a used for building or retrofitting a building. In some cases, a panel as disclosed herein can be used as a part of a wall or ceiling of a building. Alternatively or in addition to, such panel can be used as the wall or the ceiling of the building. For example, the panel comprising the composite material of the present disclosure can be used in conjunction with or in place of a dry wall.

In some cases, the composite material as disclosed herein can be cast into place, precast molded into place, or continuously extruded into place (e.g., through ceramic vacuum or vibration extrusion manufacturing equipment).

In some cases, a panel can be fabricated from a composite mixture material comprising a cellulosic material and one or both of (i) a binder material and (ii) a waterproofing material, as disclosed herein. Alternatively, a panel can be fabricated with a composite material comprising a cellulosic material (and optionally a binder material), and such fabricated panel can be subsequently modified with a waterproofing material. For example, upon fabrication of a panel comprising a composite material that comprises the cellulosic material, the waterproofing material can be applied (e.g., poured, painted on, sprayed on, dried, etc.) to one or more surfaces of the panel.

In some examples, the waterproofing material can be applied (e.g., rolled or sprayed onto) a surface of a panel as disclosed herein, and an average thickness of the waterproofing material on the surface of the panel can be at least or up to about 100 nanometers, at least or up to about 200 nanometers, at least or up to about 500 nanometers, , at least or up to about 1 micrometer, at least or up to about 2 micrometers, at least or up to about 5 micrometers, at least or up to about 10 micrometers, at least or up to about 20 micrometers, at least or up to about 50 micrometers, at least or up to about 100 micrometers, at least or up to about 200 micrometers, at least or up to about 300 micrometers, at least or up to about 400 micrometers, at least or up to about 500 micrometers, at least or up to about 600 micrometers, at least or up to about 700 micrometers, at least or up to about 800 micrometers, at least or up to about 900 micrometers, at least or up to about 1 millimeter, at least or up to about 2 millimeters, at least or up to about 3 millimeters, at least or up to about 4 millimeters, at least or up to about 5 millimeters, or at least or up to about 6 millimeters.

In some cases, the panel can comprise a porous structure (e.g., a porous cross-section). The waterproofing material may be capable of crystallizing (e.g., in the presence of a liquid, such as water) to form a network or mesh (e.g., a hydrophobic network for mesh) within the porous structure of the panel.

In some cases, a vibration extrusion system used for forming or casting the composite material into the panel can be a drycast manufacturing system (or a drycast concrete manufacturing system).

In some cases, the composite material as disclosed herein can be compressed to form the panel. In some examples, the compression can be result of subjecting the composite material in a molding, and subjecting the molding under rotation. For example, such rotation can be at least or up to about 50 rotations per minute (RMP), at least or up to about 100 RPM, at least or up to about 200 RPM, at least or up to about 500 RPM, at least or up to about 1000 RPM, at least or up to about 1500 RPM, at least or up to about 2000 RPM, at least or up to about 2500 RPM, at least or up to about 2700 RPM, at least or up to about 3000 RPM. In some examples, the composite material can be compressed under a pressure of at least or up to about 1 pound-force per square inch (psi), at least or up to about 2 psi, at least or up to about 5 psi, at least or up to about 10 psi, at least or up to about 20 psi, at least or up to about 30 psi, at least or up to about 40 psi, at least or up to about 50 psi, at least or up to about 60 psi, at least or up to about 70 psi, at least or up to about 80 psi, at least or up to about 90 psi, at least or up to about 100 psi, at least or up to about 110 psi, at least or up to about 120 psi, at least or up to about 130 psi, at least or up to about 140 psi, at least or up to about 150 psi, at least or up to about 200 psi, at least or up to about 300 psi, at least or up to about 400 psi, or at least or up to about 500 psi.

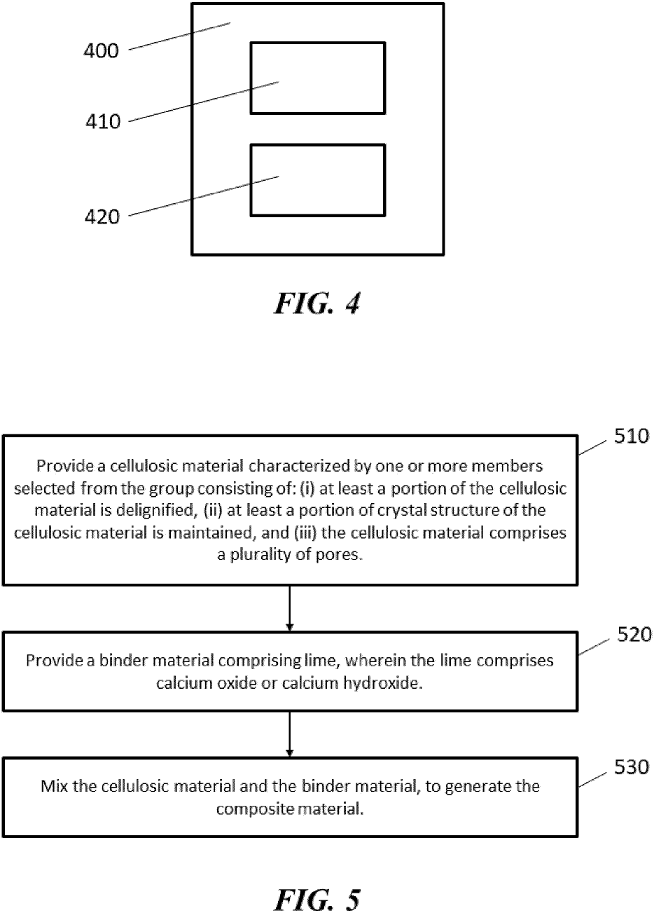

FIG. 4 shows an example composite material as disclosed herein. The composite material 400 can comprise a cellulosic material 410. The cellulosic material 410 can be characterized by one or more members selected from the group consisting of (i) at least a portion of the cellulosic material is delignified, (ii) at least a portion of crystal structure of the cellulosic material is maintained, and (iii) the cellulosic material comprises a plurality of pores. The composite material 400 can further comprise a binder material 420. The binder material 420 can comprise lime. In some cases, line can comprise calcium oxide or calcium hydroxide.

FIG. 5 shows an example flowchart 500 of a method for generating a composite material. The method can comprise providing a cellulosic material (process 510). The cellulosic material can be characterized by one or more members selected from the group consisting of: (i) at least a portion of the cellulosic material is delignified, (ii) at least a portion of crystal structure of the cellulosic material is maintained, and (iii) the cellulosic material comprises a plurality of pores. The method can further comprise providing a binder material (process 520). The binder material can comprise lime. The lime can comprise calcium oxide or calcium hydroxide. The method can further comprise mixing the cellulosic material and the binder material, to generate the composite material (process 530).

### EXAMPLES

### Example 1

In some embodiments, the cellulosic material disclosed herein may be at least partially dried by an external pressure. The external pressure may be based on screw press and/or centrifugation. Application of the external pressure may be performed without exposing the cellulosic material to a separate source of heat. Heat dewatering methods may be intensive, and may not yield uniform dewatering of a subject product, such as the cellulosic material.

In some cases, the cellulosic material may remain in a metastable crystal structure during a bleaching process. The removal of the supporting structures of lignin, hemicellulose, and/or fats from the cellulosic material may leave the cellulose crystal structure in a metastable crystal structure that is only supported by the existing water present from the bleaching process. In some cases, removal of such water must be carefully conducted in order to maintain such crystal structure without the support of water molecules. Removal of these water molecules with heat from an external heat source (e.g., in an oven) may result in a collapse of the cell wall and loss of the cellulosic crystal structure, thus yielding large diameter pores (e.g., greater than 10 micrometers) that may not be favorable to form a composite building material. In contrast, mechanical removal (e.g., without heat from an external heat source) may achieve both (i) removal or reduction of water content in the cellulosic material and (ii) yield a favorable pore size distribution (e.g., more pores having a size less than about 10 micrometers as compared to pores having a size greater than about 10 micrometers).

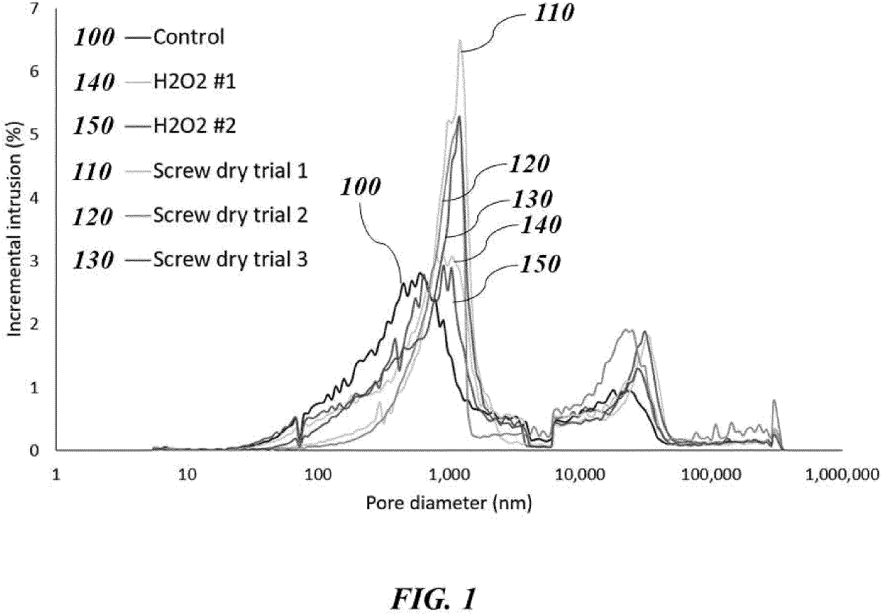

In some examples, the cellulosic material was subjected to drying by pressure, e.g., via screw press drying. As shown in FIG. 1, screw press drying the cellulosic material without exposure to an additional source of heat yielded in a population of cellulosic material with a greater amount of pores having a size less than about 10 micrometers than pores having a size greater than about 10 micrometers, as ascertains by the mercury intrusion porosimetry measurements (110, 120, 130), as compared to (i) a control (100) without the screw press drying or (ii) another control (140, 150) without the screw press drying but with a presence of hydrogen peroxide (H2O2). The hydrogen peroxide may be residual bleaching agent during the process of selective removal of, for example, lignin, hemicellulose, oils, fats, etc. Thus, pressure drying may be sufficient to transform a biomass (e.g., a cellulosic material) from a metastable waterlogged state to a sufficiently dried end product with a favorable pore size distribution.

In some embodiments, the cellulosic material (or a composite material comprising thereof) may not be dried with external heat. Alternatively or in addition to, the cellulosic material disclosed herein may be at least partially dried with heat. A temperature for heating the cellulosic material for at least partially drying the cellulosic material may be at least or up to about 35° C., at least or up to about 40° C., at least or up to about 45° C., at least or up to about 50° C., at least or up to about 55° C., at least or up to about 60° C., at least or up to about 65° C., at least or up to about 70° C., at least or up to about 75° C., at least or up to about 80° C., at least or up to about 85° C., at least or up to about 90° C., at least or up to about 95° C., at least or up to about 100° C., at least or up to about 110° C., at least or up to about 120° C., at least or up to about 130° C., at least or up to about 140° C., at least or up to about 150° C., or at least or up to about 200° C.

### Example 2

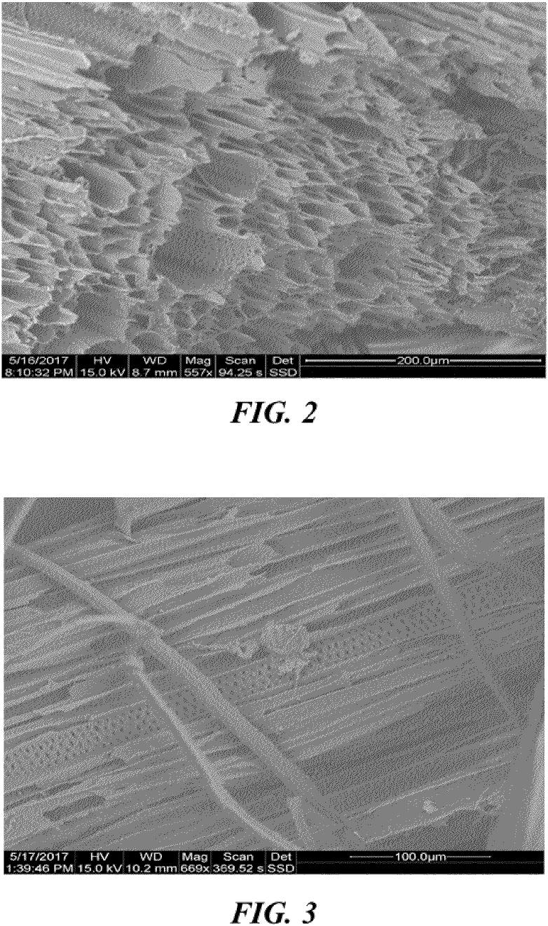

The following examples provide scanning electron microscopy (SEM) images of hemp-derived cellulosic material. FIGS. 2 and 3 shows an SEM image of a delignified industrial hemp, showing increased porosity that runs longitudinally along the fiber. Pores comprising nanopores (e.g., having a cross-sectional dimension of less than about 1 micrometer) and/or micropores (e.g., having a cross-sectional dimension of 1 micrometer or greater) are created between the cell walls upon the cellulose agglomeration. In some cases, cellulose agglomeration may occur primarily in the secondary cell walls.

While preferred embodiments of the present disclosure have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1-19. (canceled)

20. A method for generating a composite material, comprising
(a) providing (1) a cellulosic material characterized by one or more members selected from the group consisting of: (i) at least a portion of the cellulosic material is delignified, (ii) at least a portion of crystal structure of the cellulosic material is maintained, and (iii) the cellulosic material comprises a plurality of pores and (2) a binder material comprising lime, wherein the lime comprises calcium oxide or calcium hydroxide; and
(b) mixing the cellulosic material and the binder material, to generate the composite material.

21. The method of claim 20, wherein the cellulosic material is at least partially dried by an external pressure or heat.

22. (canceled)

23. The method of claim 20, wherein the lime comprises calcium oxide and calcium hydroxide.

24. The method of claim 20, binder material further comprises silica.

25. The method of claim 20, weight ratio of the silica (S) and the lime (L) is between about 1:1 and about 1:5 (S:L).

26. (canceled)

27. The method of claim 20, wherein wherein a weight of the binder material (BM) is greater than a weight of the celllulosic material (CM).

28. The method of claim 20, wherein a weight ratio of the binder material (BM) to the cellulosic material (CM) is between about 1:10 and about 30:10 .

29. The method of claim 20,further comprising exposing a mixture comprising the cellulosic material and the binder material to an external stimulus to transform the binding material into a cementitious material.

30. The method of claim 29, wherein the external stimulus comprises one or more members selected from the group consisting of carbonation, pressure, and heat.

31. The method of claim 29, wherein the external stimulus comprises hydration.

32. The method of claim 29, wherein the cementitious material comprise silicate.

33. The method of claim 20, wherein the cellulosic material comprises one or more members selected from the group consisting of a bast fiber, leaf, seed, fruit, grass, and wood.

34. The method of claim 20, wherein the cellulosic material comprises a hemp bast fiber.

35. The method of claim 20, wherein the composite material is characterized by having a density between about 1 pounds per cubic foot (lb/ft³) and about 100 lbs/ft³.

36. The method of claim 20, wherein the composite material is characterized by having a bulk density of at least about 100 lbs/ft³.

37. (canceled)

38. (canceled)

39. The method of claim 20, wherein the composite material is usable as a thermal or acoustic insulator for a building.

40. The method of claim 20, wherein the composite material exhibits a biocidal activity against a microorganism.

41. The method of claim 20, wherein the cellulosic material exhibits enhanced shelf-life as compared to a cellulosic material that does not exhibit the characterization.

42. The method of claim 20, wherein at least a portion of a hemicellulose of the cellulosic material is broken down.

43. The method of claim 20, wherein the cellulosic material characterized by having at least one component removed from the cellulosic material via a pretreatment, wherein the at least one component is selected from the group consisting of free lipids, fats, oils, sugars, and dust particles.
